(19) United States
(12) Patent Application Publication
(10) Pub. No.: US 2023/0295198 A1
(43) Pub. Date: Sep. 21, 2023

(54) VANILLIN-DERIVED FLAME RETARDANT MONOMERS, RESINS, PREPOLYMERS, AND POLYMERS

(71) Applicant: The Governing Council of the University of Toronto, Toronto (CA)

(72) Inventors: Ning Yan, Toronto (CA); Pitchaimari Gnanasekar, Tamilnadu (IN)

(21) Appl. No.: 18/011,359

(22) PCT Filed: Jun. 22, 2021
(86) PCT No.: PCT/CA2021/050855

§ 371 Date: Dec. 19, 2022

Related U.S. Application Data
(60) Provisional application No. 63/042,249, filed on Jun. 22, 2020.

(51) Int. Cl. C07F 9/53; C07F 9/6571; C07F 9/655; C09D 5/18

(52) U.S. Cl. CPC C07F 9/5337; C07F 9/65502; C07F 9/657172; C09D 5/18

(57) ABSTRACT

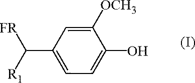

The present application relates to flame retardant compounds of Formula (I) which are derived from vanillin and which comprise a phosphorus based flame retardant. The present application also relates to methods of using compounds of Formula (I) for forming flame retardant resins, prepolymers and interpenetrating polymer network (IPNs) and to processes of their preparation. The vanillin is, for example, from a bio-based source.

### RELATED APPLICATIONS

The present application claims the benefit of priority from U.S. Provisional Pat. Application S.N. 63/042,249 filed on Jun. 22, 2020, the contents of which are incorporated herein by reference in their entirety.

### FIELD

The present application is related to flame retardant compounds derived from vanillin which comprise a phosphorus based flame retardant, and their use, for example, in forming flame retardant prepolymers, resins and polymers.

### BACKGROUND

In the 21st century, one of the major priorities is the replacement of fossil fuel based raw materials by renewable resources ^{[1]}. Nowadays, the international community is highly enthusiastic with the development of sustainable products with a strong focus on bio-based products ^{[2-4]}. Progresses have been made in integrating novel processes and technologies for efficiently converting biomass into base chemicals, platform chemicals, fuels and energy. The development of bio-based flame retardant adhesives are among these initiatives for enhancing sustainability.

For wood and wood products, flame retardant chemicals are usually added to reduce the amount of flammable gas and to increase the amount of char in order to meet the fire resistance requirement in many applications^{[5]}. Inorganic salts are common flame retardant chemicals used in wood products. However, they can be corrosive to metal fasteners and make the wood products more hygroscopic^{[6]}. The main issue surrounding these water-soluble, impregnated salt additives is that they are not bonded to the wood substrate and are leachable when wood is exposed to weathering conditions. Moreover, inorganic salts are acidic or basic in nature and may cause a reduction in wood strength by inducing hydrolysis reactions of the cellulose component in wood^{[7]}. To overcome problems of leachability, corrosivity, hygroscopicity, and strength reduction associated with these traditional flame retardants combined with the desire for more environmental-friendly products, novel flame retardants derived from bioresources are gaining attentions^{[8]}. Attempts have been made to synthesis reactive fire-retardant chemicals that can chemically bond to polymers in wood cell walls (Wood-B-FR). The types of functional groups that have been considered to bond the fire retardants (FR) to wood are epoxides (a), isocyanates (b), and anhydrides (c), which are reactive towards wood hydroxyl groups^{[9,} ^{10]}.

Vanillin (4-hydroxy-3-methoxybenzaldehyde) is one example of a biocompound that has been applied as a raw material for synthesis of various polymers and resins. It is a naturally available phenol that contains a methoxy group (—OCH₃) at the ortho-position and an aldehyde group (—CHO) present at the para-position of the phenolic ring^{[11]}. Commercially, the mono aromatic vanillin can be obtained from the conversion of lignin^{[12]}. Due to the high abundance of lignin, new methods have been developed to obtain larger quantities of vanillin from lignin^{[13]}. Nowadays vanillin has been successfully incorporated into novel polymers for use in a wide variety of commercial applications, such as commodity plastic, drug-delivery vehicle in the controlled release of resveratrol, and vinyl ester resins for composite applications^{[14-16]}. In the previous literature, Fache et al^{[17]} investigated the functionalization of vanillin and its derivatives at different oxidation states. Vanillin derivatives have been used to synthesize bio-based difunctional monomers, including epoxy monomers. The prepared epoxy materials demonstrated excellent thermal mechanical properties. However, the synthetic procedures were limited by the catalyst utilized that required a purification step. As well, some toxic reactants needed to be used, which was undesirable from an environmental friendliness viewpoint^{[18-20]}. As a result, there is a strong interest in developing epoxy monomers using renewable feedstock with less impact on the environment.

In addition, one major limitation for epoxy and polyurethanes resins is related to their flammability, which hinders their applications in fields that required fire resistance. Phosphorus containing flame retardant has gained increased attention after movements by jurisdictions around the world, such as European Union, to either ban or phase out halogenated flame retardants due to their toxicity and negative impacts on the environment^{[21]}. Among the various organophosphorus flame retardants, diphenyl phosphine oxide (DPO) has been successfully commercialized and used in epoxy resins due to its high flame-retardant efficiency and acceptable price. Usually, 9,10-dihydro-9-oxa-10-phosphaphenanthrene-10-oxide (DOPO) is directly added as a flame retardant in prepolymers of epoxy resin, and it is then covalently functionalized into the epoxy resin by reacting with the oxirane ring to form an addition product ^{[22]}. However, there are some major drawbacks for DOPO modified epoxy resins: (1) high dosage of DOPO needed, (2) decreased Tg of the cured epoxy polymer, (3) poor humidity resistance property, and (4) decreased thermal decomposing temperature^{[23-26]}. In order to overcome the aforesaid problems, many studies have been carried out to design specialized phosphorus containing derivatives with better performance. Shan Hung et al.^{[27]} showed that the epoxy resin modified by DPO had better thermal stability and comparable flame-retardant property as compared with the DOPO modified epoxy resin. DPO has a similar molecular structure to DOPO with a phosphorus content of DPO of 15.32% which is slightly higher than that of DOPO at 14.33%. In recent years, Kobilka et al.^{[28-31]} developed vanillin derived flame retardant cross linkers and monomers. The process for forming the flame retardant polymer included reacting a diol vanillin derivative and a flame retardant phosphorus based molecule such as phosphoryl or phosphonyl moiety with phenyl, allyl, epoxide, propylene carbonate, or thioether substituents to form the flame retardant vanillin derived crosslinkers and monomers. Kobilka et al.^{[28-31]} did not report any results on fire resistance testing of these novel polymers as well, their synthesis was based on vanillin derivatives by taking advantage of the available hydroxy groups for reaction.

Previous work has shown that inorganic flame retardant additives can increase the epoxy flame retardancy. However, these inorganic additives negatively affect the mechanical performance of the epoxy matrix by inducing changes in physico-chemical events occurred during the resin curing process^{[32-}^{35]}. In addition, synergistic effects in improving thermal performance have been observed when combing polyurethanes with epoxy resins ^{[36,} ^{37]}. For example, by combining epoxy resins with polyurethanes, increased thermal stability, improved mechanical properties and reduced combustibility were obtained for the final cured hybrid resins.

Typically, there are two main approaches used for combining polyurethanes and epoxy resins. The first makes use the ring opening of oxirane ring and polymerization of urethanes in the presence of the amine curing agents. The second far more established approach is to react epoxide rings with isocyanate groups in the presence of catalysts at elevated temperature leading to the formation of heterocyclic oxazolidone rings with high thermal stability^{[38]}. In both these cases, interpenetrating network (IPN) typically forms either by physical penetration of the molecular chains of polyurethane and the epoxy resins only, or by physical interpenetration plus additional chemical binding, forming a graft-IPN system. Formation of an IPN may be accompanied by partial separation of the polymer phases, which has a significant influence on the properties of the resulting product.

### SUMMARY

The Applicants have developed novel, vanillin based phosphorus containing flame retardant building blocks or precursors that, for example, can be used as a platform to develop prepolymers, resins and polymers for application, for example, as bio-based environmentally friendly fire resistant adhesives. The vanillin based phosphorous containing flame retardant building blocks are prepared by reacting the free aldehyde of the vanillin with a phosphorous moiety to provide difunctionalized vanillin based phosphorous containing flame retardant building blocks comprising, for example, two free hydroxy groups. In one embodiment, the Applicants have developed a novel difunctionalized bio-based flame retardant building block (VP) using diphenyl phosphine oxide and the naturally occurring vanillin as the starting raw materials. The difunctionalized vanillin based phosphorous containing flame retardant building blocks have been further reacted with various monomers to form flame retardant prepolymers and resins and further to form flame retardant interpenetrating polymer networks (IPN) blends.

Accordingly, the application includes a compound of Formula (I),

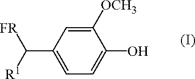

wherein,
FR is a phosphorus based flame retardant, and
R¹ is selected from OH and =O.

The present application also includes a compound of Formula (II)

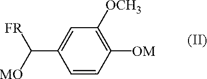

wherein
FR is a phosphorus based flame retardant, and
each M is, independently, a group comprising a polymerizable substituent.

The present application also includes a polymer of Formula (III):

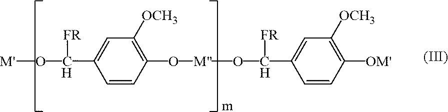

wherein
FR is a phosphorus based flame retardant;
M′ is a group comprising at least two polymerizable substituents wherein one polymerizable substituent has been reacted to form an O-linkage;
M″ is a group comprising at least two polymerizable substituents, wherein each polymerizable substituent has been reacted to form an O- linkage, and wherein the group comprising the at least two polymerizable substituents in M′ and M″ is the same; and
m is a number of repeating units.

The present application also includes an interpenetrating polymer network (IPN) comprising a blend of a compound of Formula (II) and a compound of Formula (III) wherein the compound of Formula (II) and the compound of Formula (III) are as defined above.

The present application includes a use of a compound of Formula (I) for preparing a flame retardant prepolymer and/or resin. In an embodiment, the flame retardant resin is a compound of Formula (II). In an embodiment, the flame retardant prepolymer is a compound of Formula (III).

The present application also includes a method of coating an article or a material with a flame retardant resin and/or prepolymer comprising applying a compound of Formula (II) and/or a compound of Formula (III) and optionally one or more additives, to the article or material and allowing the compound of Formula (II) and/or (III) to cure on the article or material.

The present application further includes a process for preparing a compound of Formula (I),

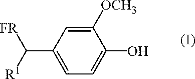

comprising:
combining vanillin

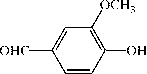 [SMILES: COc1cc(C=O)ccc1O]

with a compound of Formula (IV)

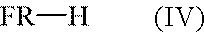

wherein
FR is a phosphorus based flame retardant, and
R¹ is OH,
under conditions to form the compound of Formula (I).

The present application also includes a process for preparing a compound of Formula (II),

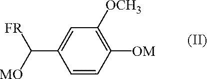

comprising:
combining a compound of Formula (I) wherein R¹ is OH;

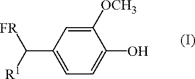

with a compound of Formula (V)

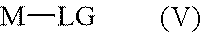

wherein
LG is a leaving group,
FR is a phosphorus based flame retardant, and
M is a group comprising a polymerizable substituent,
in the presence of a catalyst and a base under conditions to form the compound of Formula (II).

The present application also includes a process for preparing a compound of Formula (III),

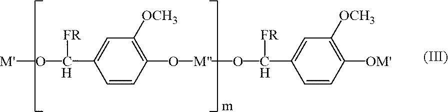

comprising :
combining a compound of Formula (I) wherein R¹ is OH

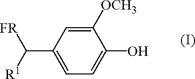

with a compound of Formula VI

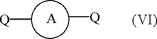

wherein
FR is a phosphorus based flame retardant;
M′ is

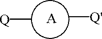

M″ is

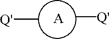

Q is a polymerizable substituent;
Q′ is a polymerizable substituent that has been reacted to form an O-linkage

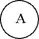

is a linker group selected from, C₁₋₁₀alkylene, C₆₋₁₆arylene and Z(C₆₋₁₆arylene)₂,
Z is selected from C₁₋₆alkylene, O, S, S═O, and NH;
FR is a phosphorus based flame retardant; and
m is a number of repeating units.
under conditions to form the compound of Formula (III).

The present application also includes a process for preparing a interpenetrating polymer network (IPN) comprising a blend of a compound of Formula (II) and a compound of Formula (III), comprising:
combining a compound of Formula (II)

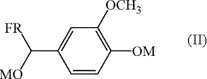

with a compound of Formula (III)

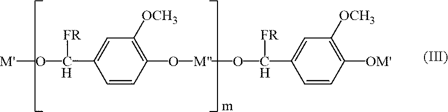

wherein
FR is a phosphorus based flame retardant;
M is a group comprising a polymerizable substituent;
M′ is a group comprising at least two polymerizable substituents wherein one polymerizable substituent has been reacted to form an O-linkage;
M″ is a group comprising at least two polymerizable substituents, wherein each polymerizable substituent has been reacted to form an O-linkage, and wherein the group comprising the at least two polymerizable substituents in M′ and M″ is the same; and
m is a number of repeating units,
and curing the compound of Formula (II) and the compound of Formula (III).

Also included in the present application is a method of preparing a flame retardant nanocomposite comprising curing a compound or Formula (II) or a compound of Formula (III) in the presence of a curing agent and optionally one or more additives as well as a nanocomposite prepared by curing a compound of Formula (II) or a compound of Formula (III) in the presence of a curing agent and optionally one or more additives

The present application also includes a method of coating an article or a material with a flame retardant nanocomposite coating comprising applying a compound of Formula (II) or a compound of Formula (III), a curing agent and optionally one or more additives, to the article or material and allowing the compound of Formula (II) or (III) to cure on the article or material as well as a material comprising a flame retardant nanocomposite coating prepared using a compound of Formula (II) or a compound of Formula (III), a curing agent and optionally one or more additives.

Other features and advantages of the present application will become apparent from the following detailed description. It should be understood, however, that the detailed description and the specific examples, while indicating embodiments of the application, are given by way of illustration only and the scope of the claims should not be limited by these embodiments, but should be given the broadest interpretation consistent with the description as a whole.

### BRIEF DESCRIPTION OF DRAWINGS

The embodiments of the application will now be described in greater detail with reference to the attached drawings in which:

FIG. 1 shows the FTIR spectra of exemplary compound of Formula (II) (VPE, II-a), exemplary compound of Formula (III) (VPU, III-a), exemplary compound of Formula (I) (VP, I-a), and diphenyl phosphine oxide (DPO), respectively.

FIG. 2 shows the dynamic mechanical analysis of comparative compound VE, exemplary compound of Formula (II) (VPE, II-a), exemplary compound of Formula (III) (VPU, III-a), and exemplary blends of an exemplary compound of Formula (II) (VPE, II-a) and an exemplary compound of Formula (III) (VPU, III-a) (storage modulus vs. temperature).

FIG. 3 shows the average lap shear strength of comparative compound VE, exemplary compound of Formula (II) (VPE, II-a), exemplary compound of Formula (III) (VPU, III-a), and exemplary blends of an exemplary compound of Formula (II) (VPE, II-a) and an exemplary compound of Formula (III) (VPU, III-a).

FIG. 4 is a scheme showing the formation of interpenetrating network structure for exemplary VPE/VPU based blends

FIG. 5 shows SEM images of the bondline in lap shear bonding test specimens glued by different adhesives: exemplary compound of Formula (II) (VPE, II-a), and exemplary compound of Formula (III) (VPU, III-a) (with a thinner bondline); and exemplary IPN blends VPE85, and VPE80 (with a thicker bondline

FIG. 6 shows TGA curves of comparative vanillin-based phosphorus free (VE) and exemplary phosphorus containing epoxy (VPE, II-a), exemplary polyurethane (VPU, III-a) and their blends.

FIG. 7 shows the gas chromatogram of the decomposition products from (A) exemplary compound of Formula (II) (VPE, II-a) and (B) exemplary compound of Formula (III) (VPU, III-a).and mass spectra of the corresponding GC graph evidently showing the presence of DPO and DMI in the gas phase from combustion of (C) exemplary compound of Formula (II) (VPE, II-a and (D) exemplary compound of Formula (III) (VPU, III-a).

FIG. 8 shows the possible mass fragmentation during thermal degradation processes for (a) phosphorus containing vanillin segment from both exemplary compound of Formula (III) (VPU, III-a) and exemplary compound of Formula (II) (VPE, II-a) (b) DMI segment from exemplary compound of Formula (III) (VPU, III-a).

FIG. 9 shows the digital photos of the char residues after UL-94 burning tests of exemplary compound of Formula (II) (VPE, II-a), exemplary compound of Formula (III) (VPU, III-a), and exemplary blends.

FIG. 10 shows cone calorimetry test results (A) Heat Release Rate (HRR) curves, (B) Total Heat Release Rate (THR) curves and (C) Total Smoke Production Rate (TSP) curves.

FIG. 11 shows the FTIR spectra of char residues of exemplary compound of Formula (II) (VPE, II-a) and exemplary blends VPE95, VPE90, VPE85 and VPE80.

FIG. 12 is a graph showing the relationship between reaction extent (α) and activation energies (Ea) during the curing reactions of exemplary neat VPE and exemplary VPE/ FGO nanocomposites systems.

FIG. 13 is a schematic showing an exemplary proposed curing process between VPE and DDS.

FIG. 14 is a schematic showing an exemplary VPE-FGO-DDS trimolecular transition complex.

FIG. 15 shows pictures of samples VPE that was cured in the microwave using: A - the protocol described in Example 2(i), and B - the protocol described in Example 2(ii).

### DETAILED DESCRIPTION

### I. Definitions

Unless otherwise indicated, the definitions an embodiments described in this and other sections are intended to be applicable to all embodiments and aspects of the present application herein described for which they are suitable as would be understood by a person skilled in the art.

The term “compound(s) of the present application” and the like as used herein refers to compounds of Formula (I), (II) and/or (III). Also included are various forms and isomers of the compounds of Formula (I), (II) and/or (III), such as salts, solvates, enantiomers, tautomers and the like.

The term “solvate” as used herein means a compound, or a salt of a compound, wherein molecules of a suitable solvent are incorporated in the crystal lattice. A suitable solvent is physiologically tolerable at the dosage administered.

The term “salt” means either an acid addition salt or a base addition salt of a compound of the application. An acid addition salt is any organic or inorganic acid addition salt of any basic compound of the application. A base addition salt is any organic or inorganic base addition salt of any acidic compound of the application.

In embodiments of the present application, the compounds described herein may have at least one asymmetric center. Where compounds possess more than one asymmetric center, they may exist as diastereomers. It is to be understood that all such isomers and mixtures thereof in any proportion are encompassed within the scope of the present application. It is to be further understood that while the stereochemistry of the compounds may be as shown in any given compound listed herein, such compounds may also contain certain amounts (for example, less than 20%, suitably less than 10%, more suitably less than 5%) of compounds of the present application having alternate stereochemistry. It is intended that any optical isomers, as separated, pure or partially purified optical isomers or racemic mixtures thereof are included within the scope of the present application.

The compounds of the present application may also exist in different tautomeric forms and it is intended that any tautomeric forms which the compounds form are included within the scope of the present application.

The term “and/or” as used herein means that the listed items are present, or used, individually or in combination. In effect, this term means that “at least one of” or “one or more” of the listed items is used or present. The term “and/or” with respect to pharmaceutically acceptable salts and/or solvates thereof means that the compounds of the application exist as individual salts and hydrates, as well as a combination of, for example, a solvate of a salt of a compound of the application.

As used in the present application, the singular forms “a”, “an” and “the” include plural references unless the content clearly dictates otherwise. For example, an embodiment including “a compound” should be understood to present certain aspects with one compound, or two or more additional compounds.

In embodiments comprising an “additional” or “second” component, such as an additional or second compound, the second component as used herein is chemically different from the other components or first component. A “third” component is different from the other, first, and second components, and further enumerated or “additional” components are similarly different.

As used in this application and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

The term “consisting” and its derivatives as used herein are intended to be closed terms that specify the presence of the stated features, elements, components, groups, integers, and/or steps, and also exclude the presence of other unstated features, elements, components, groups, integers and/or steps.

The term “consisting essentially of”, as used herein, is intended to specify the presence of the stated features, elements, components, groups, integers, and/or steps as well as those that do not materially affect the basic and novel characteristic(s) of these features, elements, components, groups, integers, and/or steps.

The term “suitable” as used herein means that the selection of the particular compound or conditions would depend on the specific synthetic manipulation to be performed, the identity of the molecule(s) to be transformed and/or the specific use for the compound, but the selection would be well within the skill of a person trained in the art. All process/method steps described herein are to be conducted under conditions sufficient to provide the product shown. A person skilled in the art would understand that all reaction conditions, including, for example, reaction solvent, reaction time, reaction temperature, reaction pressure, reactant ratio and whether or not the reaction should be performed under an anhydrous or inert atmosphere, can be varied to optimize the yield of the desired product and it is within their skill to do so.

The terms “about”, “substantially” and “approximately” as used herein mean a reasonable amount of deviation of the modified term such that the end result is not significantly changed. These terms of degree should be construed as including a deviation of at least ±5% of the modified term if this deviation would not negate the meaning of the word.

The present description refers to a number of chemical terms and abbreviations used by those skilled in the art. Nevertheless, definitions of selected terms are provided for clarity and consistency.

The term “alkyl” as used herein, whether it is used alone or as part of another group, means straight or branched chain, saturated alkyl groups. The number of carbon atoms that are possible in the referenced alkyl group are indicated by the prefix “Cₙ₁₋ₙ₂”. For example, the term C₁₋₁₀alkyl means an alkyl group having 1, 2, 3, 4, 5, 6, 7, 8, 9 or 10 carbon atoms.

The term “alkylene”, whether it is used alone or as part of another group, means straight or branched chain, saturated alkylene group, that is, a saturated carbon chain that contains substituents on two of its ends. The number of carbon atoms that are possible in the referenced alkylene group are indicated by the prefix “Cₙ₁₋ₙ₂”. For example, the term C₂₋₆alkylene means an alkylene group having 2, 3, 4, 5 or 6 carbon atoms.

The term “aryl” as used herein, whether it is used alone or as part of another group, refers to carbocyclic groups containing at least one aromatic ring and contains from 6 to 14 carbon atoms, such as phenyl, indanyl, fluorenyl, naphthyl and anthracenyl.

The term “arylene” as used herein, whether alone or as part of another group, refers to carbocyclic groups containing at least one aromatic ring and contains from 6 to 14 carbon atoms and that contains substituents on two of its ends, such as phenylene, indanylene, fluorenylene, naphthylene and anthracenylene.

All cyclic groups, including aryl and cycloalkyl groups, contain one or more than one ring (i.e. are polycyclic). When a cyclic group contains more than one ring, the rings may be fused, bridged or spirofused.

The term “ring system” as used herein refers to any cyclic group, that includes monocycles, fused bicyclic and polycyclic rings, and bridged rings in which the rings are saturated, unsaturated and/or aromatic. Where specified, the carbons in the rings may be substituted or replaced with heteroatoms.

The term “polycyclic” as used herein means cyclic groups that contain more than one ring linked together and includes, for example, groups that contain two (bicyclic), three (tricyclic) or four (quadracyclic) rings. The rings may be linked through a single atom (spirocyclic) or through two atoms (fused and bridged).

The term “benzofused” as used herein refers to a polycyclic group in which a benzene ring is fused with another ring.

A first ring being “fused” with a second ring means the first ring and the second ring share two adjacent atoms there between.

A first ring being “bridged” with a second ring means the first ring and the second ring share two non-adjacent atoms there between.

A first ring being “spirofused” with a second ring means the first ring and the second ring share one atom there between.

The terms “halo” or “halogen” as used herein, whether it is used alone or as part of another group, refers to a halogen atom and includes fluoro, chloro, bromo and iodo.

The term “available”, as in “available hydrogen atoms” or “available atoms” refers to atoms that would be known to a person skilled in the art to be capable of replacement by a substituent.

The term “protecting group” or “PG” and the like as used herein refers to a chemical moiety which protects or masks a reactive portion of a molecule to prevent side reactions in those reactive portions of the molecule, while manipulating or reacting a different portion of the molecule. After the manipulation or reaction is complete, the protecting group is removed under conditions that do not degrade or decompose the remaining portions of the molecule. The selection of a suitable protecting group can be made by a person skilled in the art. Many conventional protecting groups are known in the art, for example as described in “Protective Groups in Organic Chemistry” McOmie, J.F.W. Ed., Plenum Press, 1973, in Greene, T.W. and Wuts, P.G.M., “Protective Groups in Organic Synthesis”, John Wiley & Sons, 3^{rd} Edition, 1999 and in Kocienski, P. Protecting Groups, 3rd Edition, 2003, Georg Thieme Verlag (The Americas).

The term “deuterated” as used herein means that one or more, including all, of the hydrogens on a group are replaced with deuterium (I.e. [²H].

The products of the processes of the application may be isolated according to known methods, for example, the compounds may be isolated by evaporation of the solvent, by filtration, centrifugation, chromatography or other suitable method.

The term “vanillin” as used herein refers to a compound having the IUPAC name 4-hydroxy-3-methoxybenzaldehyde and having the chemical Formula:

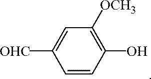

The term “phosphorus based flame retardant” as used herein refers to any compound comprising at least one phosphorus atom that acts as a flame retardant and that can be reacted with vanillin to provide a compound of Formula I.

The term “flame retardant” as used herein refers to compounds that are activated by the presence of an ignition source and are intended to prevent or slow the further development of ignition by a variety of different physical and chemical methods.

The term “resin” as used herein refers to substance that is convertible into a polymer. The substance is generally a solid or highly viscous.

The term “prepolymer” as used herein refers to a substance this is convertible into a polymer upon curing.

The term “DPO” as used herein refers a compound having the IUPAC name diphenyl phosphine oxide and having the chemical Formula:

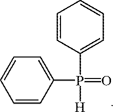

The term “VP” as used herein refers to the compound of Formula (I-a) and having the IUPAC name (hydroxy(4-hydroxy-3-methoxyphenyl)methyl) diphenylphosphine oxide.

The term “VPE” or “vanillin based phosphorus containing epoxy resin” as used herein refers to the compound of Formula (II-a) and having the IUPAC name ((3-methoxy-4-(oxiran-2-ylmethoxy)phenyl)(oxiran-2-ylmethyloxy)methyl)diphenyl phosphine oxide.

The term “VE” or “vanillin epoxy” as used herein refers to a compound having the IUPAC name (2-((2-methoxy-4-((oxiran-2-ylmethoxy)methyl)phenoxy)methyl)oxirane, and having the chemical Formula

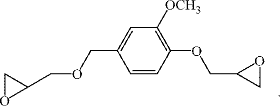

The term “VPU” or “phosphorus containing vanillin based polyurethane polymer resin” as used herein refers to the compound of Formula (III-a).

The term “polymerizable substituent” as used herein refers to a substitutent which can be polymerized in a polymerization reaction.

The term “EPIKURE™ 3271” is a commercially available curing agent which is a modified ethylene diamine.

The term “interpenetrating polymer network” or “IPN” as used herein refers to an interpenetrating polymer network structure, which is a network of two or more polymer blends with molecular chains interpenetrating and at least one polymer molecular chain interlinked by chemical bonds.

The term “nanocomposite” as used herein refers to a multiphase solid material where one of the phases has one, two or three dimensions of less than 100 nanometers (nm) or structures having nano-scale repeat distances between the different phases that make up the material.

The term “leaving group” or “LG” as used herein refers to a group that is readily displaceable by a nucleophile, for example, under nucleophilic substitution reaction conditions.

Ms as used herein refers to a mesyl substiuent.

Ts as used herein refers to a tosyl substituent

Tf as used herein refers to triflate substituent.

### II. Compounds of the Application

The Applicants have developed novel, vanillin based phosphorus containing flame retardant building blocks or precursors that, for example, can be used as a platform to develop prepolymers, resins and polymers for application, for example, as bio-based environmentally friendly fire resistant adhesives. The vanillin based phosphorous containing flame retardant building blocks are prepared by reacting the free aldehyde of the vanillin with a phosphorous moiety to provide difunctionalized vanillin based phosphorous containing flame retardant building blocks comprising, for example, two free hydroxy groups. In one exemplary embodiment, the Applicants have developed a novel difunctionalized bio-based flame retardant building block (VP) using diphenyl phosphine oxide and the naturally occurring vanillin as the starting raw materials. The difunctionalized vanillin based phosphorous containing flame retardant building blocks have been further reacted with various monomers to form flame retardant prepolymers and resins, and further to form flame retardant polymers and interpenetrating polymer networks (IPN) blends. In one exemplary embodiment, a difunctionalized vanillin based phosphorous containing flame retardant building block (VP) was reacted with epichlorohydrin and diphenyl methane diisocyanate (DMI) to prepare flame retardant vanillin epoxy (VPE) resin and vanillin polyurethane (VPU) prepolymer. An interpenetrating polymer network (IPN) blends comprising a blend of a compound of Formula (II) and a compound of Formula (III) have been also prepared. Structural characterizations of the synthesized resins, prepolymers and IPNs were carried out in detail.

In exemplary embodiments, using a blending technique, a series of VPU and VPE IPN blends were prepared by varying weight ratios of the two resins ranging from VPU: VPE = 5:95, 10:90, 15:85, 20:80, 25:75 and 30:70. In addition, chemical, thermal, mechanical, bondline morphology and flame retardant properties of the VPE, VPU and their blends were studied systematically. It was found that VPU gave higher bonding strength, but lower flame resistance (according to UL-94 vertical burning test) than VPE. However, the VPE:VPU blends showed strong synergistic effects that resulted in much higher bonding strength and flame resistance than that of neat VPE resin and VPU prepolymers alone, for example, due to the formation of strong interpenetrating polymer networks (IPN). In addition, the thermal gravimetric analysis, limited oxygen index (LOI) and cone calorimetry tests revealed that thermal stability and flame retardant properties of the blends were enhanced with the increase in the content of VPU with the VPU:VPE=20:80 blend giving the best performance achieving a highest LOI index of 29.6% and lowest peak heat release rate. While not wishing to be limited by theory, gas chromatography/mass spectroscopy study of char residues indicated that the flame-retardant mechanism was attributed to the quenching effect of phosphorus-containing free radicals and diluting effect of non-flammable gases in the gas phase, and the formation of phosphorus-rich char layers in the condensed phase. Therefore, the Applicants have developed a process for synthesizing bio-based sustainable platform chemicals with high performance fire retardancy and adhesion properties, and a new family of fire resistant and thermally stable bio-based epoxy resin and polyurethane prepolymers based on renewable feedstock.

Accordingly, the application includes a compound of Formula (I),

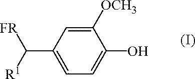

wherein,
FR is a phosphorus based flame retardant, and
R¹ is selected from OH and =O.

In an embodiment, R¹ is OH and the compound of Formula (I) is a compound of Formula (I-A),

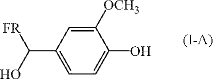

In an embodiment, FR is selected from,

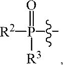

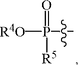

and

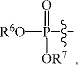

wherein
R², R³, R⁴, R⁵, R⁶ and R⁷ are independently selected from C₆₋₁₄aryl, C₁₋₁₀alkyl, C₂₋₁₀alkenyl, and C₂₋₁₀alkynyl, each of which are unsubstituted or substituted with one or more of F, CI, C₁₋₄alkyl and C₁₋₄fluoroalkyl, or
R² and R³, R⁴ and R⁵ or R⁶ and R⁷ are linked to form, together with the atom(s) to which said groups are bonded, a monocyclic or a polycyclic, saturated, unsaturated and/or aromatic ring system having 4 or more carbon atoms in which one or more of the carbon atoms is optionally replaced with a heteroatom selected from O and N and which is unsubstituted or substituted with one or more of F, Cl and C₁₋₄alkyl; and
is a point of covalent attachment.

In an embodiment, R², R³, R⁴, R⁵, R⁶ and R⁷ are independently selected from C₆₋₁₄aryl, C₁₋₁₀alkyl, C₂₋₁₀alkenyl, and C₂₋₁₀alkynyl. In an embodiment, R², R³, R⁴, R⁵, R⁶ and R⁷ are independently selected from C₆₋₁₄aryl, C₁₋₆alkyl, C₂₋₆alkenyl, and C₂₋₆alkynyl. In an embodiment, R², R³, R⁴, R⁵, R⁶ and R⁷ are independently selected from C₆₋₁₄aryl and C₂₋₆alkenyl. R², R³, R⁴, R⁵, R⁶ and R⁷ are independently selected from phenyl, naphthyl, indanyl, fluorenyl and anthracenyl. In an embodiment, R², R³, R⁴, R⁵, R⁶ and R⁷ are independently selected from phenyl and naphthyl. In an embodiment, R², R³, R⁴, R⁵, R⁶ and R⁷ are phenyl. In an embodiment, R², R³, R⁴, R⁵, R⁶ and R⁷ are allyl.

In an embodiment, one of R² and R³, R⁴ and R⁵ or R⁶ and R⁷ is phenyl and the other is C₂₋₆alkenyl, such as allyl.

In an embodiment, R² and R³, R⁴ and R⁵ or R⁶ and R⁷ are linked to form, together with the atom(s) to which said groups are bonded, a monocyclic or a polycyclic, saturated, unsaturated and/or aromatic ring system having 6 or more carbon atoms in which one or more of the carbon atoms is optionally replaced with a heteroatom selected from O and N and which is unsubstituted or substituted with one or more of F, CI and C₁₋₄alkyl. In an embodiment, R² and R³, R⁴ and R⁵ or R⁶ and R⁷ are linked to form, together with the atom(s) to which said groups are bonded, a polycyclic, saturated, unsaturated and/or aromatic ring system having 6-14 carbon atoms in which 1-4 of the carbon atoms is optionally replaced with a heteroatom selected from O and N and which is unsubstituted or substituted with one or more of F, Cl and C₁₋₄alkyl. In an embodiment, R² and R³, R⁴ and R⁵ or R⁶ and R⁷ are linked to form, together with the atom(s) to which said groups are bonded, a polycyclic, saturated, unsaturated and/or aromatic ring system having 6-14 carbon atoms in which 1-2 of the carbon atoms is optionally replaced with a heteroatom selected from O and N and which is unsubstituted or substituted with one or more of F, Cl and C₁₋₄alkyl.

In an embodiment, FR is

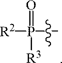

In embodiment, one of R² and R³ is phenyl and the other is C₂₋₆alkenyl. In embodiment, one of R² and R³ is phenyl and the other is allyl. In an embodiment, R² and R³ are both phenyl and FR is

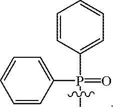

In an embodiment, FR is

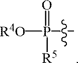

In embodiment, one of R⁴ and R⁵ is phenyl and the other is C₂₋₆alkenyl. In embodiment, one of R⁴ and R⁵ is phenyl and the other is allyl. In an embodiment, R⁴ and R⁵ are both phenyl and FR is

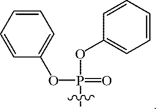

In an embodiment, FR is

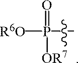

In embodiment, one of R⁶ and R⁷ is phenyl and the other is C₂₋₆alkenyl. In an embodiment one of R⁶ and R⁷ is phenyl and the other is allyl. In an embodiment, R⁶ and R⁷ are both phenyl.

In an embodiment, R⁶ and R⁷ are linked together to form, together with the atoms to which said groups are bonded, a polycyclic ring system having 6 to 14 carbon atoms, in which one of the carbon atoms is replaced with O. In an embodiment, FR is

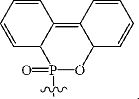

In an embodiment, the compound of Formula (I) is selected from

| | |
|---|---|
| Compound I.D | Structure |
| I-a (VP) | 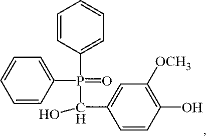 |
| I-b | 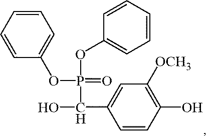 |
| I-c | 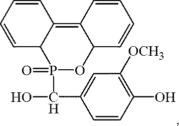 |
| I-d | 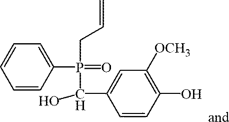 |
| I-e | 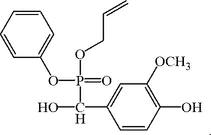 |

In an embodiment, the compound of Formula (I) is a compound of Formula (I-a) (VP)

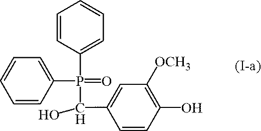 [SMILES: COc1cc(C(O)P(=O)(c2ccccc2)c2ccccc2)ccc1O]

In an embodiment, the compound of Formula (I) is bound to a resin. In an embodiment, the compound of Formula (I) is bound to a polymer.

The present application also includes a compound of Formula (II)

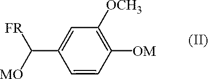

wherein
FR is a phosphorus based flame retardant, and
each M is, independently, a group comprising a polymerizable substituent.

In an embodiment, FR is selected from

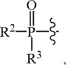

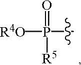

and

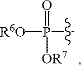

wherein R², R³, R⁴, R⁵, R⁶ and R⁷ are as defined above for Formula (I).

In an embodiment, the polymerizable substituent in M is selected from a methacryloyl, an epoxy, an alkenyl, an alkynyl, a cyanato, and an isocyanato, each being either directly bonded to the O or linked to the O via a linker group. In some embodiments the linker group is C(O)NH, NHC(O), C₁₋₁₀alkylene, phenylene, diphenylene, diphenylene methane, diphenylene sulfoxide, diphenylene sulfone or diphenylene ether, or combinations thereof. In some embodiments the linker group is C(O)NH, NHC(O), C₁₋₁₀alkylene, phenylene, diphenylene, diphenylene methane, diphenylene sulfone or diphenylene ether, or combinations thereof. In some embodiments the linker group is C(O)NH, NHC(O), C₁₋₆alkylene, phenylene, diphenylene, diphenylene methane, diphenylene sulfoxide, diphenylene sulfone or diphenylene ether, or combinations thereof. In some embodiments the linker group is C(O)NH, NHC(O), C₁₋₆alkylene, phenylene, diphenylene, diphenylene methane, diphenylene sulfone or diphenylene ether, or combinations thereof. In some embodiments the linker group is C₁₋₄alkylene, C(O)NH-diphenylene methane, C(O)NH-diphenylene sulfoxide, C(O)NH-diphenylene sulfone or C(O)NH-diphenylene ether. In some embodiments the linker group is C₁₋₄alkylene, C(O)NH-diphenylene methane, C(O)NH-diphenylene sulfone or C(O)NH-diphenylene ether.

In an embodiment, M is selected from

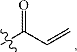

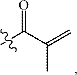

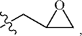

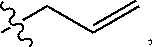

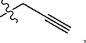

CH₂OCN and CH₂NCO, wherein

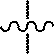

is a point of covalent attachment.

In an embodiment, M is

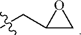

In an embodiment, M is

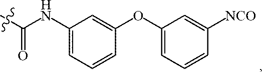

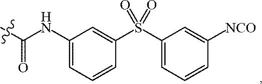

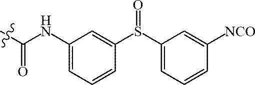

or

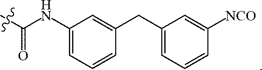

In an embodiment, M is

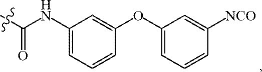

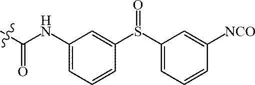

or

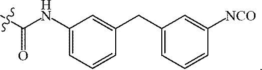

In an embodiment, the compound of Formula (II) is a compound of Formula (II-a) (VPE).

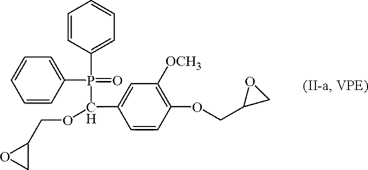 [SMILES: COc1cc(C(OCC2CO2)P(=O)(c2ccccc2)c2ccccc2)ccc1OCC1CO1]

In some embodiments, the compound of Formula (II) is a compound of Formula II-b:

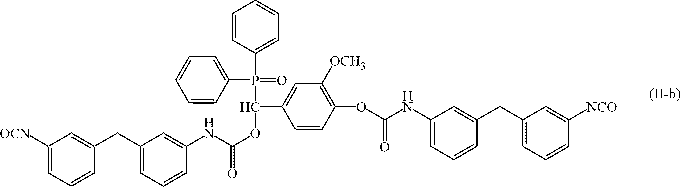

In an embodiment the compound of Formula (I) is reacted with a monomer comprising two polymerizable substituents to produce a polymer of Formula (III):

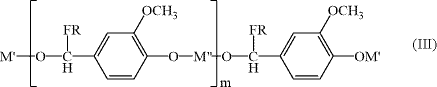

wherein
FR is a phosphorus based flame retardant;
M′ is a group comprising at least two polymerizable substituents wherein one polymerizable substituent has been reacted to form an O-linkage;
M″ is a group comprising at least two polymerizable substituents, wherein each polymerizable substituent has been reacted to form an O- linkage, and wherein the group comprising the at least two polymerizable substituents in M′ and M″ is the same; and
m is a number of repeating units.

In an embodiment, m is an integer selected from 2 to 5.

In an embodiment, FR is selected from

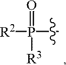

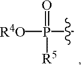

and

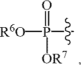

wherein R², R³, R⁴, R⁵, R⁶ and R⁷ are as defined above for Formula (I).

In an embodiment, at least two polymerizable substituents in M′ or M″ are independently selected from a methacryloyl, an epoxy, an alkenyl, an alkynyl, a cyanato, and an isocyanato, each being either directly bonded to the O or linked to the O via a linker group. In some embodiments the linker group is C(O)NH, NHC(O), C₁₋₁₀alkylene, phenylene, diphenylene, diphenylene methane, diphenylene sulfoxide, diphenylene sulfone or diphenylene ether, or combinations thereof. In some embodiments the linker group is C(O)NH, NHC(O), C₁₋₁₀alkylene, phenylene, diphenylene, diphenylene methane, diphenylene sulfone or diphenylene ether, or combinations thereof. In some embodiments the linker group is C(O)NH, NHC(O), C₁₋₆alkylene, phenylene, diphenylene, diphenylene methane, diphenylene sulfoxide, diphenylene sulfone or diphenylene ether, or combinations thereof. In some embodiments the linker group is C(O)NH, NHC(O), C₁₋₆alkylene, phenylene, diphenylene, diphenylene methane, diphenylene sulfone or diphenylene ether, or combinations thereof. In some embodiments the linker group is C₁₋₄alkylene, C(O)NH-diphenylene methane, C(O)NH-diphenylene sulfoxide, C(O)NH-diphenylene sulfone or C(O)NH-diphenylene ethe.r In some embodiments the linker group is C₁₋₄alkylene, C(O)NH-diphenylene methane, C(O)NH-diphenylene sulfone or C(O)NH-diphenylene ether.

In an embodiment, the group comprising at least two polymerizable substituents wherein one polymerizable substituent has been reacted to form an O-linkage in M′ is

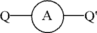

wherein
Q is a polymerizable substituent;
Q′ is a polymerizable substituent that has been reacted to form an O-linkage.

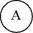

is a linker group selected from C₁₋₁₀alkylene, C₆₋₁₄arylene, and Z(C₆₋₁₄arylene)₂, and
Z is selected from C₁₋₆alkylene, O, S, SO₂, S═O, and NH.

In an embodiment, Q is selected from a methacryloyl, an epoxy, an alkenyl, an alkynyl, a cyanato, and an isocyanato.

In an embodiment, Q is selected from —OCN and —NCO. In an embodiment, Q is —NCO.

In an embodiment,

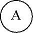

is C₆₋₁₆arylene. In an embodiment, the C₆₋₁₀aryl is selected from phenylene, naphthylene or indanylene. In an embodiment, the C₆₋₁₀arylene is phenylene.

In an embodiment, Z is selected from C₁₋₆alkylene, O, S═O, and NH.

In an embodiment,

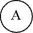

is Z(C₆₋₁₆arylene)₂. In an embodiment, Z is selected from C₁₋₄alkylene, O, SO₂, and S═O. In an embodiment, Z is selected from C₁₋₄alkylene, O, and S═O. In an embodiment, is selected from

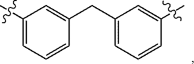

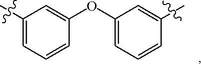

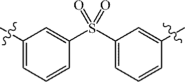

and

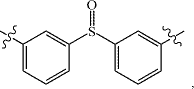

wherein is a point of covalent attachment. In an embodiment,

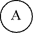

is selected from

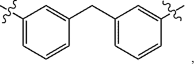

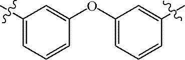

and

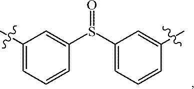

wherein

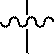

is a point of covalent attachment. In an embodiment,

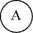

is

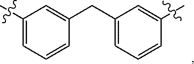

wherein

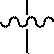

is a point of covalent attachment.

In an embodiment, Q′ is selected from a methacryloyl, an epoxy, an alkenyl, an alkynyl, a cyanato, and an isocyanato that has been reacted to from an O-linkage.

In an embodiment, Q′ is selected from

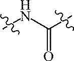

and

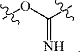

. In an embodiment Q′ is

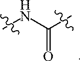

In an embodiment, the group comprising at least two polymerizable substituents, wherein each polymerizable substituent has been reacted to form an O- linkages in M″ is

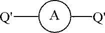

wherein

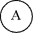

and Q′ are as defined for M′.

In an embodiment, the compound of Formula (III) is a compound of Formula (III-A)

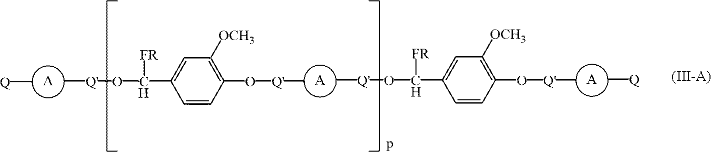

wherein
Q is selected from —OCN and —NCO;

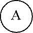

is selected from

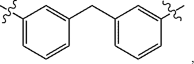

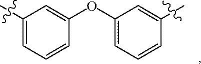

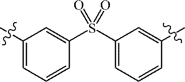

and

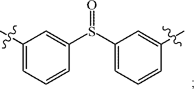

Q′ is selected from

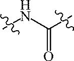

and

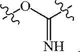

p is a number of repeating units; and

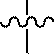

is a point of covalent attachment.

In an embodiment,

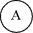

is selected from

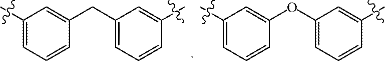

and

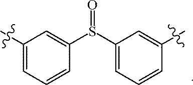

In an embodiment, p is an integer selected from 2 to 5.

In an embodiment, Q is —NCO and Q′ is

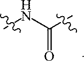

In an embodiment, the compound of Formula (III) is a compound of Formula (III-a) (VPU), 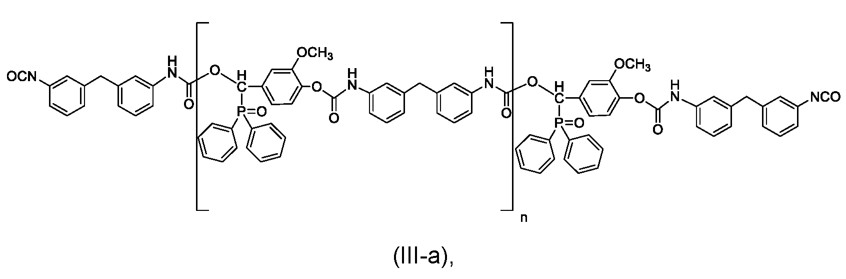 wherein n is a number of repeating units.

In an embodiment, n is an integer selected from 2 to 5.

The present application also includes an interpenetrating polymer network (IPN) comprising a blend of a compound of Formula (II) and a compound of Formula (III) wherein the compound of Formula (II) and the compound of Formula (III) are as defined above.

In an embodiment, the IPN comprises a compound of Formula (II) and a compound of Formula (III) in a weight ratio of about 99 to about 1, about 95 to about 5, about 90 to about 10, about 85 to about 15, about 80 to about 20, about 75 to about 25, about 70 to about 30 or about 65 to about 35 of a compound of Formula (II) to a compound of Formula (III). In an embodiment, the IPN comprises a compound of Formula (II) and a compound of Formula (III) in a weight ratio of about 90 to about 10, about 85 to about 15, about 80 to about 20, or about 75 to about 25 of a compound of Formula (II) to a compound of Formula (III). In an embodiment, the IPN comprises a compound of Formula (II) and a compound of Formula (III) in a weight ratio of about 85 to about 15 or about 80 to about 20 of a compound of Formula (II) to a compound of Formula (III).

In an embodiment, the compound of Formula (II) is as defined above.

In an embodiment, the compound of Formula (III) is as defined above.

In an embodiment, the compound of Formula (II) is a compound of Formula (II-a) as defined above.

In an embodiment, the compound of Formula (III) is a compound of Formula (III-a) as defined above.

In an embodiment, the compounds of Formula (II) or the compounds of Formula (III) are cured in the presence of a curing agent and optionally in the presence of one or more additives to provide flame-retardant nanocomposites. Accordingly the present application also includes a nanocomposite prepared by curing a compound of Formula (II) or a compound of Formula (III) in the presence of a curing agent and optionally one or more additives. In an embodiment, the one or more additives is graphene oxide (GO) and/or functionalized graphene oxide (FGO) which is added to the compound of Formula (II) or the compound of Formula (III) prior to curing. In some embodiments, the FGO is GO that is non-covalently functionalized with a flame retardant compound. In an embodiment, the flame retardant compound is phosphorus and nitrogen containing flame retardant compound, such as dibenzyl N,N-diethyl phosphoramidite (DDP). In an embodiment, the weight faction of the flame retardant additive in the VPE is about 1 wt% to about 20 wt%, about 2 wt% to about 15 wt%, about 3 wt% to about 10 wt%, about 5 wt% to about 9 wt% or about 7 wt%. In an embodiment, the curing agent is any suitable curing agent. In an embodiment, the curing agent is selected from aliphatic amines, aromatic amines, modified alkylene diamines and other diamines, polyamide resins, secondary amines, tertiary amines, imidazoles, polymercaptans, amino acids and anhydrides. In an embodiment, the curing agent is a aliphatic diamine or an aromatic diamine. In an embodiment, the curing agent is 4,4′-diaminodiphenylsulfone (DDS) or an ethylene diamine.

### III. Methods and Uses of the Application

The Applicants have developed novel, vanillin based phosphorus containing flame retardant building blocks or precursors that, for example, can be used as a platform to develop prepolymers, resins, interpenetrating polymer networks (IPN) and polymers for application, for example, as bio-based environmentally friendly fire retardant resins and polymers that can be used, for example, as fire retardant adhesives to various materials.

Accordingly, the present application includes a use of a compound of Formula (I) for preparing a flame retardant resin. In an embodiment, the flame retardant resin is a compound of Formula (II). In an embodiment, the flame retardant resin is an epoxy resin.

The present application includes a use of a compound of Formula (I) for preparing a flame retardant prepolymer. In an embodiment, the flame retardant prepolymer is a compound of Formula (III). In an embodiment, the flame retardant prepolymer is a polyurethane prepolymer.

The present application also includes a use of one or more compounds of Formula (II) as a flame retardant resin. In an embodiment, the present application also includes a use of one or more compound of Formula (III) as a flame retardant prepolymer. The present application also includes a use of an interpenetrating polymer network (IPN) comprising a blend of a compound of Formula (II) and a compound of Formula (III) as a flame retardant polymer.

It has been shown the blends of a compounds of Formula (II) and a compound of Formula (III) have strong synergistic effects that result in much higher bonding strength and flame resistance than that of compounds of Formula (II) or compounds of Formula (III) resins alone, for example, due to the formation of strong interpenetrating polymer networks (IPN). Accordingly, the present application further includes a use of one or more compounds of Formula (II) for preparing an interpenetrating polymer network (IPN). The present application also includes a use of one or more compounds of Formula (III) for preparing an interpenetrating polymer network (IPN). The present application further includes a use of one or more compounds of Formula (II) in combination with one or more compound of Formula (III) for preparing an interpenetrating polymer network (IPN).

In an embodiment, the flame retardant resin, prepolymer or polymer can be used for preparing a flame retardant adhesive. Accordingly, the present application also includes a use of a compound of Formula (I) for preparing a flame retardant adhesive. In an embodiment, the present application also includes a use of one or more compounds of Formula (II) for preparing a flame retardant adhesive. In an embodiment, the flame retardant adhesive is an epoxy adhesive. In an embodiment, the present application also includes a use of one or more compound of Formula (III) for preparing a flame retardant adhesive. In an embodiment, the flame retardant adhesive is a polyurethane adhesive. The present application also includes a use of an interpenetrating polymer network (IPN) comprising a blend of a compound of Formula (II) and a compound of Formula (III) for preparing a flame retardant adhesive.

The present application as includes a method of preparing a flame retardant adhesive comprising curing a compound of Formula II, a compound of Formula III, and/or an interpenetrating polymer network (IPN) comprising a blend of a compound of Formula (II) and a compound of Formula (III) and/or and optionally one or more additives.

The present application also includes a flame retardant adhesive prepared using one or more compounds of Formula (I). The present application also includes a flame retardant adhesive prepared using one or more compound of Formula (II) and/or one or more compounds of Formula (III). The present application further includes a flame retardant adhesive prepared using an interpenetrating polymer network (IPN) comprising a blend of a compound of Formula (II) and a compound of Formula (III).

The present application as includes a method of preparing a flame retardant adhesive comprising curing a compound of Formula II, a compound of Formula III, and/or an interpenetrating polymer network (IPN) comprising a blend of a compound of Formula (II) and a compound of Formula (III)and/or and optionally one or more additives.

In an embodiment, the adhesive is a bio-adhesive, an elastomer, a thermoplastic, an emulsion or a thermoset.

In an embodiment, the adhesive further comprises suitable additives. In an embodiment, the additive is an organic material and/or an inorganic material. In an embodiment, the additive is silica, carbon black, graphene, graphene oxide, carbon nanotubes, inorganic clays and/or alumina silicates. In an embodiment, the additive is graphene oxide. In an embodiment, the additive is functionalized graphene oxide.

In an embodiment, the adhesive is applied to a material.

The present application also includes a method of preparing a flame retardant nanocomposite comprising curing a compound or Formula (II) or a compound of Formula (III) in the presence of a curing agent and optionally one or more additives. In an embodiment, the flame retardant nanocomposite is a flame retardant nanocomposite coating. In an embodiment, the one or more additives is graphene oxide (GO) and/or functionalized graphene oxide (FGO) which is added to the compound of Formula (II) or the compound of Formula (III) prior to curing. In some embodiments, the FGO is GO that is non-covalently functionalized with a flame retardant compound. In an embodiment, the flame retardant compound is phosphorus and nitrogen containing flame retardant compound, such as dibenzyl N,N-diethyl phosphoramidite (DDP). In an embodiment, the weight faction of the flame retardant additive in the nanocomposite is about 1 wt% to about 20 wt%, about 2 wt% to about 15 wt%, about 3 wt% to about 10 wt%, about 5 wt% to about 9 wt% or about 7 wt%. In an embodiment, the curing agent is any suitable curing agent. In an embodiment, the curing agent is selected from aliphatic amines, aromatic amines, modified alkylene diamines and other diamines, polyamide resins, secondary amines, tertiary amines, imidazoles, polymercaptans, amino acids and anhydrides. In an embodiment, the curing agent is a diamine such 4,4′-diaminodiphenylsulfone (DDS) or an ethylene diamine. In embodiment, a stoichiometric amount of curing agent is used. In an embodiment, the curing is performed by heating to a temperature of about 80° C. to about 100° C. or about 90° C. In an embodiment the curing is performed in a microwave. In an embodiment, the microwave conditions comprise any conditions suitable to deliver sufficient energy to the sample for curing. A person skilled in the art would appreciate that larger samples will require more energy and longer curing times and are able to determine suitable energies, microwave frequencies and times to use. In an embodiment, the samples to be cured are first evaporated to remove any solvent prior to curing. In an embodiment the microwave curing or activation is performed at 100% power and heating for about 1 minute to about 5 minutes, or about 2 minutes to about 3 minutes, followed by cooling at room temperature for about 1 minute and repeating this cycle (heating and cooling) 1-10, 3-7 or 5 times.

The present application also includes a use of a compound of Formula (II) or a compound of Formula (III) to prepare a flame retardant nanocomposite.

The application further includes a method of coating an article or a material with a flame retardant resin and/or prepolymer comprising applying a compound of Formula II and/or a compound of Formula III, and optionally one or more additives, to the article or material and allowing the compound of Formula (II) and/or (III) to cure on the article or material. The present application also includes a method of coating an article or a material with a flame retardant polymer comprising applying a blend of a compound of Formula (II) and a compound of Formula (III), and optionally one or more additives, to the article or material and allowing the blend of the compound of Formula (II) and the compound of Formula (III) to cure on the article or material.

The present application also includes a material comprising a flame retardant coating prepared using one or more compounds of Formula (II) and/or one or more compounds of Formula (III), and optionally one or more additives. The present application further includes a material comprising a flame retardant coating prepared using an interpenetrating polymer network (IPN) comprising a blend of a compound of Formula (II) and a compound of Formula (III), and optionally one or more additives.

In an embodiment, the material is wood, wood products paper, textiles, plastics or articles of manufacture. In an embodiment, the material is wood or wood products.

The application further includes a method of coating an article or a material with a flame retardant nanocomposite coating comprising applying a compound of Formula II or a compound of Formula III, a curing agent and optionally one or more additives, to the article or material and allowing the compound of Formula (II) or (III) to cure on the article or material.

The present application also includes a material comprising a flame retardant nanocomposite coating prepared using a compound of Formula (II) or a compound of Formula (III), a curing agent and optionally one or more additives. In an embodiment, the material is wood, wood products paper, textiles, plastics or articles of manufacture. In an embodiment, the material is wood orwood products.

In an embodiment, the article of manufacture is an electronic component. In an embodiment, the electronic component is a circuit board, a semiconductor, a transistor, an optoelectronic, a capacitor or a resistor.

### IV. Processes for Preparation of the Application

The Applicants have developed processes for synthesizing vanillin based phosphorus containing flame retardant building blocks. The vanillin based phosphorous containing flame retardant building blocks are prepared by reacting the free aldehyde of the vanillin with a phosphorous moiety to provide difunctionalized vanillin-based phosphorous containing flame retardant building blocks comprising, for example, two free hydroxy groups.

Accordingly, the application includes a process for preparing a compound of Formula (I), comprising:

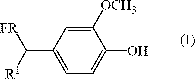 [SMILES: COc1cc(C=O)ccc1O]

combining vanillin

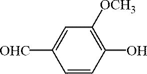

with a compound of Formula (IV)

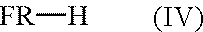

wherein
FR is a phosphorus based flame retardant, and
R¹ is OH,
under conditions to form the compound of Formula (I).

In an embodiment, FR is selected from

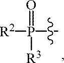

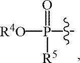

and

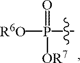

wherein
R², R³, R⁴, R⁵, R⁶ and R⁷ are independently selected from C₆₋₁₄aryl, C₁₋₁₀alkyl, C₂₋₁₀alkenyl, and C₂₋₁₀alkynyl, each of which are unsubstituted or substituted with one or more of F, CI, C₁₋₄alkyl and C₁₋₄fluoroalkyl, or
R² and R³, R⁴ and R⁵ or R⁶ and R⁷ are linked to form, together with the atom(s) to which said groups are bonded, a monocyclic or a polycyclic, saturated, unsaturated and/or aromatic ring system having 4 or more carbon atoms in which one or more of the carbon atoms is optionally replaced with a heteroatom selected from O and N and which is unsubstituted or substituted with one or more of F, CI and C₁₋₄alkyl; and

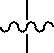

is a point of covalent attachment.

In an embodiment, FR is

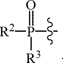

In embodiment, one of R² and R³ is phenyl and the other is C₂₋₆alkenyl. In embodiment, one of R² and R³ is phenyl and the other is allyl. In an embodiment, R² and R³ are both phenyl and FR is

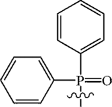 [SMILES: O=[PH](c1ccccc1)c1ccccc1]

and the compound of Formula (IV) is

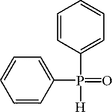

(DPO).

In an embodiment, FR is

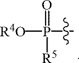

In embodiment, one of R⁴ and R⁵ is phenyl and the other is C₂₋₆alkenyl. In embodiment, one of R⁴ and R⁵ is phenyl and the other is allyl. In an embodiment, R⁴ and R⁵ are both phenyl and FR is

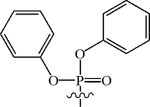

and the compound of Formula (IV) is

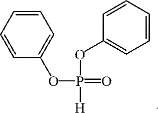

In an embodiment, FR is

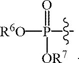

In embodiment, one of R⁶ and R⁷ is phenyl and the other is C₂₋₆alkenyl. In an embodiment one of R⁶ and R⁷ is phenyl and the other is allyl. In an embodiment, R⁶ and R⁷ are both phenyl.

In an embodiment, R⁶ and R⁷ are linked together to form, together with the atoms to which said groups are bonded, a polycyclic ring system having 6 to 14 carbon atoms, in which one of the carbon atoms is replaced with O. In an embodiment, FR is

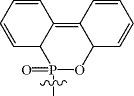

and the compound of Formula (IV) is

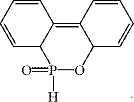

In an embodiment, the compound of Formula (I) is selected from

| | |
|---|---|
| Compound I.D | Structure |
| I-a (VP) | 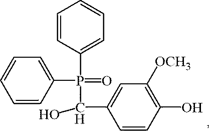 |
| I-b | 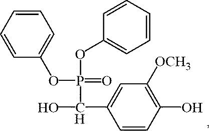 |
| I-c | 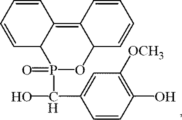 |
| I-d | 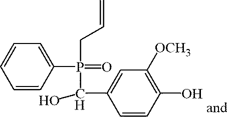 |
| I-e | 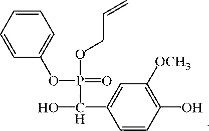 [SMILES: COc1cc(C(O)P(=O)(c2ccccc2)c2ccccc2)ccc1O] |

In an embodiment, the compound of Formula (I) is a compound of Formula (I-a) (VP)

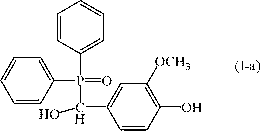

In an embodiment, wherein the conditions to form the compound of Formula (I) wherein R¹ is OH comprise combining the vanillin and the compound of Formula (IV) in a solvent to form a reaction mixture.

In an embodiment, the solvent is dried. In an embodiment, the solvent is a non polar hydrocarbon solvent. In an embodiment, the solvent is selected from xylene, benzene, toluene, hexane, hexanes and heptane. In an embodiment, the solvent is toluene.

In an embodiment, the conditions to form the compound of Formula (I) wherein R¹ is OH comprise combining the vanillin and the compound of Formula (IV) in the solvent with the addition of excess amounts of the compound of Formula (IV). In an embodiment, the conditions to form the compound of Formula (I) wherein R¹ is OH comprise combining the vanillin and the compound of Formula (IV) in the solvent with the addition of, for example, about 2 to about 5, about 2 to about 4, about 2 to about 3, about 2 to about 2.5 or about 2 molar equivalents the compound of Formula (IV) relative to the vanillin. In an embodiment, the conditions to form the compound of Formula (I) wherein R¹ is OH comprise combining the vanillin and the compound of Formula (IV) in the solvent with the addition of, for example with about 2 molar equivalents of the compound of Formula (IV) relative to the amount of the vanillin.

In an embodiment, the combining is performed by mixing the vanillin and the compound of Formula (IV).

In an embodiment, the conditions to form the compound of Formula (I) wherein R¹ is OH comprise heating the reaction mixture to the boiling point (refluxing temperature) of the solvent. In an embodiment, the conditions to form the compound of Formula (I) wherein R¹ is OH comprise heating the reaction mixture to about 80° C. to about 140° C., about 80° C. to about 130° C., about 80° C. to about 120° C., about 90° C. to about 120° C., about 100° C. to about 120° C., or about 110° C. to about 120° C. In an embodiment, the conditions to form the compound of Formula (I) wherein R¹ is OH comprise heating the reaction mixture to about 120° C.

In an embodiment, the conditions to form the compound of Formula (I) wherein R¹ is OH comprise heating the reaction mixture for about 2 hours to about 8 hours, about 3 hours to about 7 hours, or about 4 hours to 6 hours; or about 2 hours, about 3 hours, about 4 hours, about 5 hours, about 6 hours, or about 7 hours. In an embodiment, the conditions to form the compound of Formula (I) wherein R¹ is OH comprise heating the reaction mixture for about 4 hours to 6 hours; or about 5 hours

In an embodiment, the conditions to form the compound of Formula (I) wherein R¹ is OH further comprise combining the vanillin and the compound of Formula (IV) in the solvent under an inert atmosphere. In an embodiment, the inert atmosphere is a nitrogen atmosphere.

In an embodiment, the conditions to form the compound of Formula (I) wherein R¹ is OH comprise combining the vanillin and the compound of Formula (IV) in the solvent under an inert atmosphere to form the reaction mixture and heating the reaction mixture to a temperature of about 120° C. for about 5 hours.

In an embodiment, after heating, the reaction mixture is cooled, for example, to room temperature, and the compound of Formula (I) is separated from the reaction mixture, for example, by filtration with washing with the solvent to provide the wet compound of Formula (I) wherein R¹ is OH. The compound of Formula (I) wherein R¹ is OH is then dried, for example, under vacuum to provide the compound of Formula (I).

In an embodiment, the process provides the compound of Formula (I) wherein R¹ is OH in a yield of greater than about 85%, about 90% or about 95%. In an embodiment, the process provides the compound of Formula (I) in a yield of greater an about 55%, about 60%, about 65%, about 70%, about 75%, about 80%, about 85%, about 90%, about 95%, about 96%, about 97%, about 98% or about 99%. In an embodiment, the process provides the compound of Formula (I) in a yield of about 95%, about 96%, or about 97%.

It would be appreciated by a person skilled in the art that a compound of Formula (I) wherein R¹ is =O can be obtained by the oxidation of a compound of Formula (I) wherein R¹ is OH (Formula I-A).

In an embodiment, the application also includes a compound of Formula (I) wherein R¹ is OH prepared by the method described above.

In an embodiment, the vanillin is from a bio-based source. In an embodiment, the bio-based source is lignin or a lignin derivative.

In an embodiment, the compound of Formula (IV) is available from commercial sources or can be prepared using methods known in the art.

The present application also includes a process for preparing a compound of Formula (II), comprising

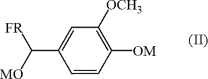

combining a compound of Formula (I) wherein R¹ is OH;

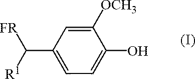

with a compound of Formula (V)

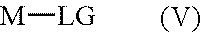

wherein
LG is a leaving group,
FR is a phosphorus based flame retardant, and
M is a group comprising a polymerizable substituent,
in the presence of a catalyst and a base under conditions to form the compound of Formula (II).

In an embodiment, FR is selected from

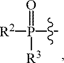

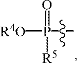

and

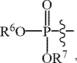

wherein
R², R³, R⁴, R⁵, R⁶ and R⁷ are independently selected from C₆₋₁₄aryl, C₁₋₁₀alkyl, C₂₋₁₀alkenyl, and C₂₋₁₀alkynyl, each of which are unsubstituted or substituted with one or more of F, CI, C₁₋₄alkyl and C₁₋₄fluoroalkyl, or
R² and R³, R⁴ and R⁵ or R⁶ and R⁷ are linked to form, together with the atom(s) to which said groups are bonded, a monocyclic or a polycyclic, saturated, unsaturated and/or aromatic ring system having 4 or more carbon atoms in which one or more of the carbon atoms is optionally replaced with a heteroatom selected from O and N and which is unsubstituted or substituted with one or more of F, Cl and C₁₋₄alkyl; and

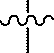 [SMILES: COc1cc(C(O)P(=O)(c2ccccc2)c2ccccc2)ccc1O]

is a point of covalent attachment.

In an embodiment, the compound of Formula (I) is a compound of Formula (I-a) (VP)

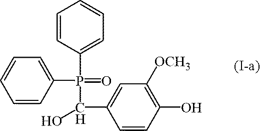

In an embodiment, the polymerizable substituent in M is selected from a methacryloyl, an epoxy, an alkenyl, an alkynyl, a cyanato, and an isocyanato, each being either directly bonded to the O or linked to the O via a linker group. In some embodiments the linker group is C(O)NH, NHC(O), C₁₋₁₀alkylene, phenylene, diphenylene, diphenylene methane, diphenylenesulfoxide, diphenylene sulfone or diphenylene ether, or combinations thereof. In some embodiments the linker group is C(O)NH, NHC(O), C₁₋₁₀alkylene, phenylene, diphenylene, diphenylene methane, diphenylene sulfone or diphenylene ether, or combinations thereof. In some embodiments the linker group is C(O)NH, NHC(O), C₁₋₆alkylene, phenylene, diphenylene, diphenylene methane, diphenylene sulfoxide, diphenylene sulfone or diphenylene ether, or combinations thereof. In some embodiments the linker group is C(O)NH, NHC(O), C₁₋₆alkylene, phenylene, diphenylene, diphenylene methane, diphenylene sulfone or diphenylene ether, or combinations thereof. In some embodiments the linker group is C₁-₄alkylene, C(O)NH-diphenylene methane, C(O)NH-diphenylene sulfoxide, C(O)NH-diphenylene sulfone or C(O)NH-diphenylene ether. In some embodiments the linker group is C₁-₄alkylene, C(O)NH-diphenylene methane, C(O)NH-diphenylene sulfone or C(O)NH-diphenylene ether.

In an embodiment, M is selected from

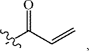

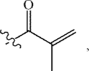

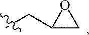

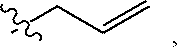

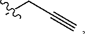

CH₂OCN and CH₂NCO, wherein

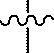

is a point of covalent attachment.

In an embodiment, M is

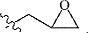

In an embodiment, M is

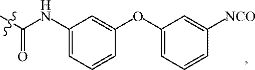

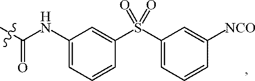

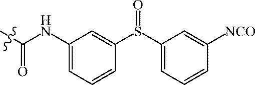

or

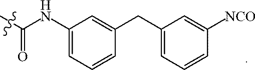

In an embodiment, M is

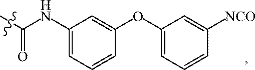

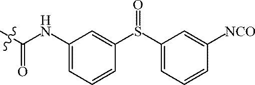

or

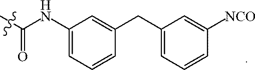

In an embodiment, LG is selected from halo, Ms, Ts, Tf, C₁₋₆acyl. In an embodiment, the halo is selected from F, Cl and Br. In an embodiment, the halo is Cl.

In an embodiment, M is

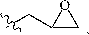

and LG is Cl.

In an embodiment, the catalyst is a phase transfer catalyst. In an embodiment, the phase transfer catalyst is benzyltriethylammonium chloride (TEBAC).

In an embodiment, the base is an inorganic base. In an embodiment, the base is sodium hydroxide or potassium hydroxide. In an embodiment, the base is sodium hydroxide. In an embodiment, the sodium hydroxide is a 2 M, 3 M, 4 M, 5 M, 6 M or 7 M sodium hydroxide solution. In an embodiment, the sodium hydroxide is a 5 M sodium hydroxide solution.

In an embodiment, the compound of Formula (II) is a compound of Formula (II-a) (VPE):

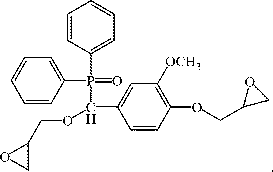

In some embodiments, the compound of Formula (II) is a compound of Formula II-b:

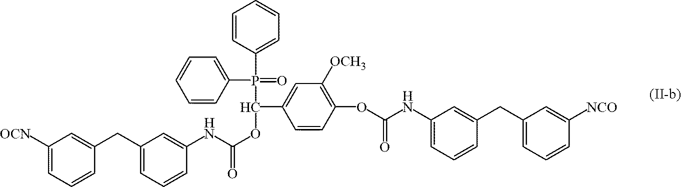

In an embodiment, the conditions to form the compound of Formula (II) comprise combining the compound of Formula (I) wherein R¹ is OH and the compound of Formula (V) with the addition of excess amounts of the compound of Formula (V). In an embodiment, the conditions to form the compound of Formula (II) comprise combining the compound of Formula (I) wherein R¹ is OH and the compound of Formula (V) with the addition of, for example, about 5 to about 15, about 7 to about 12, about 8 to about 12, about 9 to about 10 or about 10 molar equivalents the compound of Formula (V) relative to the compound of Formula (I). In an embodiment the conditions to form the compound of Formula (II) comprise combining the compound of Formula (I) wherein R¹ is OH with about 10 molar equivalents of the compound of Formula (V) relative to the amount of the compound of Formula (I) wherein R¹ is OH.

In an embodiment, the conditions to form the compound of Formula (II) comprise combining the compound of Formula (I) wherein R¹ is OH and the compound of Formula (V) at room temperature.

In an embodiment, the conditions to form the compound of Formula (II) comprise combining the compound of Formula (I) wherein R¹ is OH and the compound of Formula (V) for about 0.5 hours to about 3 hours, about 1 hour to about 3 hours, or about 1 hours to about 2 hours; or about 0.5 hours, about 1 hours, about 1.5 hours, about 2 hours, about 2.5 hours, or about 3 hours in the presence of the catalyst before the addition of the base to form a first reaction mixture. In an embodiment the conditions to form the compound of Formula (II) comprise combining the compound of Formula (I) wherein R¹ is OH and the compound of Formula (V) for about 1 hours to 2 hours; or about 1.5 hours in the presence of the catalyst before the addition of the base to form a first reaction mixture.

In an embodiment the combining of the compound of Formula (I) wherein R¹ is OH and the compound of Formula (V) is by mixing.

In an embodiment, the conditions to form the compound of Formula (II) comprise cooling the first reaction mixture, for example, to room temperature, and adding the base and a further amount of the catalyst to form a second reaction mixture.

In an embodiment, the second reaction mixture is mixed for about 15 minutes to about 45 minutes, about 20 minutes to about 40 minutes or about 25 minutes to about 35 minutes, or about 30 minutes.

In an embodiment, the process further comprises, after mixing, extracting the second reaction mixture. In an embodiment, the extraction is performed with a two phase mixture of ethyl acetate and water. In an embodiment, the extraction in repeated two times. In an embodiment, the organic phase comprising the compound of Formula (II) is dried using a drying agent such as magnesium sulfate. In an embodiment, excess compound of Formula (V) is removed by evapouration, for example, rotoevapouration to provide the compound of Formula (II).

In an embodiment, the process provides the compound of Formula (II) in a yield of greater than about 85%, about 90% or about 95%. In an embodiment, the process provides the compound of Formula (I) in a yield of greater an about 55%, about 60%, about 65%, about 70%, about 75%, about 80%, about 85%, about 90%, about 95%, about 96%, about 97%, about 98% or about 99%. In an embodiment, the process provides the compound of Formula (I) in a yield of about 95%.

In an embodiment, the application also includes a compound of Formula (II) prepared by the method described above.

In embodiment, the compound of Formula (II) is a flame retardant resin and therefore the process for preparing a compound of Formula (II) is a process for preparing a flame retardant resin.

In an embodiment, compound of Formula (V) is available from commercial sources or can be prepared using methods known in the art.

The present application also includes a process for preparing a compound of Formula (III), comprising

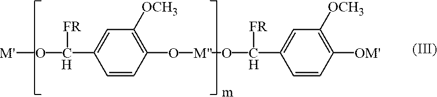

combining a compound of Formula (I) wherein R¹ is OH

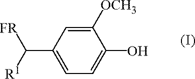

with a compound of Formula VI

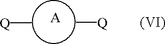

wherein
FR is a phosphorus based flame retardant;
M′ is

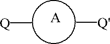

M″ is

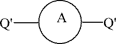

Q is a polymerizable substituent;
Q′ is a polymerizable substituent that has been reacted to form an O-linkage

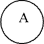

is a linker group selected from, C₁₋₁₀alkylene, C₆₋₁₆aryl and Z(C₆₋₁₆aryl)₂,
Z is selected from C₁₋₆alkylene, O, S, S═O, and NH;
FR is a phosphorus based flame retardant; and
m is a number of repeating units.
under conditions to form the compound of Formula (III).

In an embodiment,

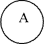

is C₆₋₁₆arylene. In an embodiment, the C₆₋₁₀aryenel is selected from phenylene, naphthylene or indanylene. In an embodiment, the C₆₋₁₀aryl is phenylene.

In an embodiment,

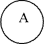

is Z(C₆₋₁₆arylene)₂. In an embodiment, Z is selected from C₁-₄alkylene, O, SO₂, and S═O. In an embodiment, Z is selected from C₁-₄alkylene, O, and S═O. In an embodiment,

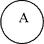

is selected from

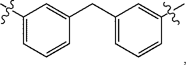

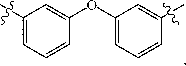

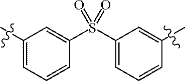

and

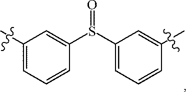

wherein

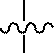

is a point of covalent attachment. In anembodiment,

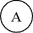

is selected from

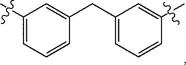

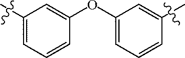

and

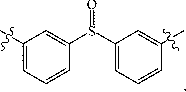

wherein

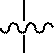

is a point of covalent attachment. In an embodiment,

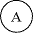

is

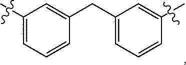

wherein

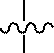

is a point of covalent attachment.

In an embodiment, Q is selected from a methacryloyl, an epoxy, an alkenyl, an alkynyl, a cyanato, and an isocyanato.

In an embodiment, Q is selected from —OCN and —NCO. In an embodiment, Q is —NCO.

In an embodiment, Q′ is selected from a methacryloyl, an epoxy, an alkenyl, an alkynyl, a cyanato, and an isocyanato that has been reacted to form an O-linkage.

In an embodiment, Q′ is selected from

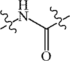

and

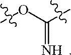

In an embodiment Q′ is

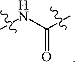

In an embodiment, the combining is performed by mixing the compound of Formula (I) and the compound of Formula (VI).

In an embodiment, the conditions to form the compound of Formula (III) comprises combining the compound of Formula (I) and (VI) in a suitable solvent to form a reaction mixture, such as dimethyl formamide (DMF).

In an embodiment, the process further comprises dehydrating the compound of Formula (I) wherein R¹ is OH before the step of combining. In an embodiment, the dehydrating is under reduced pressure. In an embodiment, the dehydrating is performed for about 1 hours, about 2 hours or about 3 hours. In an embodiment, the dehydrating is performed for about 2 hours.

In an embodiment, the conditions to form the compound of Formula (III) comprise combining the compound of Formula (I) wherein R¹ is OH in a solvent with the addition of excess amounts of the compound of Formula (VI). In an embodiment, the conditions to form the compound of Formula (III) comprise combining the compound of Formula (I) wherein R¹ is OH in the solvent with the addition of, for example, about 2 to about 5, about 2 to about 4, about 2 to about 3, about 2 to about 2.5 or about 2 molar equivalents of the compound of Formula (VI) relative to the compound of Formula (I) wherein R¹ is OH. In an embodiment, the conditions to form the compound of Formula (III) comprise combining the compound of Formula (I) wherein R¹ is OH in the solvent with the addition of, for example with about 2 molar equivalents of the compound of Formula (VI) relative to the amount of the compound of Formula (I) wherein R¹ is OH.

In an embodiment, the conditions to form the compound of Formula (III) comprise heating the reaction mixture to the boiling point (refluxing temperature) of the solvent.

In an embodiment, the conditions to form the compound of Formula (III) comprise heating the reaction mixture for about 2 hours to about 8 hours, about 3 hours to about 7 hours, or about 4 hours to 6 hours; or about 2 hours, about 3 hours, about 4 hours, about 5 hours, about 6 hours, or about 7 hours. In an embodiment, the conditions to form the compound of Formula (I) comprise heating the reaction mixture for about 4 hours to 6 hours; or about 5 hours.

In an embodiment, the conditions to form the compound of Formula (I) further comprise combining the compound of Formula (I) wherein R¹ is OH in a solvent and the compound of Formula (VI) under an inert atmosphere. In an embodiment, the inert atmosphere is a nitrogen atmosphere.

In an embodiment, after heating, the reaction mixture is cooled, for example, to room temperature, and excess solvent is removed such as by evaporation to provide the compound of Formula (III).

In an embodiment, the process provides the compound of Formula (III) in a yield of greater than about 85%, about 90% or about 95%. In an embodiment, the process provides the compound of Formula (III) in a yield of greater an about 55%, about 60%, about 65%, about 70%, about 75%, about 80%, about 85%, or about 90%. In an embodiment, the process provides the compound of Formula (I) in a yield of about 91%, about 92%, or about 93 %.

In an embodiment, the application also includes a compound of Formula (III) prepared by the method described above.

In an embodiment, the compound of Formula (VI) is available from commercial sources or can be prepared using methods known in the art.

In an embodiment, the present application also includes a interpenetrating polymer network (IPN) comprising a blend of a compound of Formula (II) and a compound of Formula (III) wherein the compound of Formula (II) and the compound of Formula (III) are as defined above.

In an embodiment, the compound of Formula (III) is a flame retardant resin or polymer, therefore the process of preparing a compound of Formula (III) is a process for preparing a flame retardant resin or polymer.

In an embodiment, the application also includes a compound of Formula (III) prepared by the method described above.

The present application also includes a process for preparing a flame retardant interpenetrating polymer network (IPN) comprising a blend of a compound of Formula (II) and a compound of Formula (III), comprising
combining a compound of Formula (II)

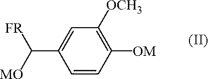

with a compound of Formula (III)

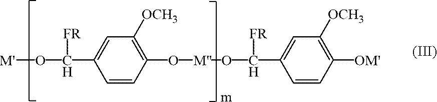

wherein
FR is a phosphorus based flame retardant;
M is a group comprising a polymerizable substituent;
M′ is a group comprising at least two polymerizable substituents wherein one polymerizable substituent has been reacted to form an O-linkage;
M″ is a group comprising at least two polymerizable substituents, wherein each polymerizable substituent has been reacted to form an O-linkage, and wherein the group comprising the at least two polymerizable substituents in M′ and M″ is the same; and
m is a number of repeating units,
and curing the compound of Formula (II) and the compound of Formula (III).

In an embodiment, the combining is performed by mixing the compound of Formula (II) and the compound of Formula (III).

In an embodiment, the combining is performed using a homogenizer. Accordingly, in an embodiment, the combining is homogenizing.

In an embodiment, the curing is by thermal activation or by photopolymerization. In an embodiment, the curing is by thermal activation. In an embodiment, the curing is in the presence of a curing agent. In an embodiment, the curing agent is selected from aliphatic amines, aromatic amines, modified alkylene diamines, polyamide resins, secondary amines, tertiary amines, imidazoles, polymercaptans, amino acids and anhydrides. In an embodiment, the curing agent is a modified ethylene diamine. In an embodiment, the curing agent is EPIKURE®. In an embodiment the curing agent is a diamine such as 4,4′-diaminodiphenylsulfone (DDS).

In an embodiment the curing is by microwave activation.

In an embodiment, the process further comprises preblending the compound of Formula (II) and the compound of Formula (III) without a curing agent before the step of combining the compound of Formula (II) and the compound of Formula (III) in the presence of the curing agent. In an embodiment, the preblending is performed using a homogenizer. In an embodiment, the preblending is performed for about 5 minutes, about 10 minutes, about 15 minutes, about 20 minutes or about 30 minutes. In an embodiment, the preblending is performed for about 15 minutes.

In an embodiment, the conditions to form the IPN comprise combining the compound of Formula (II) and the compound of Formula (III) in the presence of a curing agent using a homogenizer. In an embodiment, the combining in the presence of a curing agent is performed for about 5 minutes, about 10 minutes, about 15 minutes, about 20 minutes or about 30 minutes. In an embodiment, the blending is performed for about 5 minutes.

In an embodiment, the process further comprises placing the IPN in a mold.

In an embodiment, the compound of Formula (II) and the compound of Formula (III) are combined in a weight ratio of about 99 to about 1, about 95 to about 5, about 90 to about 10, about 85 to about 15, about 80 to about 20, about 75 to about 25 about 70 to about 30 or about 65 to about 35 of a compound of Formula (II) to a compound of Formula (III). In an embodiment, the compound of Formula (II) and the compound of Formula (III) are combined in a weight ratio of about 90 to about 10, about 85 to about 15, about 80 to about 20, or about 75 to about 25 of a compound of Formula (II) to a compound of Formula (III). In an embodiment, the compound of Formula (II) and the compound of Formula (III) are combined in a weight ratio of about 85 to about 15 or about 80 to about 20 of a compound of Formula (II) to a compound of Formula (III).

In an embodiment, the compound of Formula (II) is as defined above.

In an embodiment, the compound of Formula (III) is as defined above.

In an embodiment, the compound of Formula (II) is a compound of Formula (II-a) as defined above.

In an embodiment, the compound of Formula (III) is a compound of Formula (III-a) as defined above.

In an embodiment, the application also includes an IPN comprising a blend of a compound of Formula (II) and a compound of Formula (III) prepared by the method described above.

### EXAMPLES

The following non-limiting examples are illustrative of the present application.

### Example 1

### A. Experimental

### A) Materials

All chemicals were used without further purification except dimethylformamide (DMF) which was purified by distillation under reduced pressure over calcium hydride. Diphenyl phosphine oxide (DPO) was purchased from Qingdao Fusilin Chemical Science and Technology Co., Ltd. (Qingdao, China). Epichlorohydrin (99%), vanillin (99%), benzyltriethylammonium chloride (TEBAC) (99%), sodium hydroxide (97%), ethyl acetate, tetrahydrofuran, toluene, acetic acid, methanol, vanillyl alcohol (99%), diphenyl methane diisocyanate (MDI) (99%), and Epikure Curing Agent 3271 were purchased from Sigma Aldrich. Epikure Curing Agent 3271 is a modified aliphatic amine (diethylenetriamine) and was used as the hardener with an amine hydrogen equivalent weight of 34 g/eq.

### B) Synthesize of Exemplary Compound of Formula (I) (I-a, (VP)

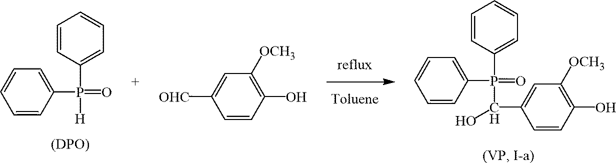

In a 500 ml round-bottom flask, 13.4 parts of vanillin (0.1 mol), 47.5 parts of diphenyl phosphine oxide (DPO) (0.22 mol) and dry toluene (250 ml) were introduced and agitate under nitrogen atmosphere. The solution mixture was then heated to 120° C. and refluxed for about 5 h. The reaction solution then thickened due to the precipitation of the resulting phosphorus containing vanillin product (hydroxy(4-hydroxy-3-methoxy phenyl)methyl) diphenylphosphine oxide, (VP. I-a)). After being cooled to room temperature, the precipitant was filtered and washed with toluene. The obtained solid was then dried in vacuum at 71° C. to give a white product with a 97% yield. Molecular formula of the product is C₂₀H₂₀PO₄. ¹H NMR (400 MHz, DMSO-d6) (δ, ppm): 7.70, 7.75, 7.81 (m, 6H, i), 7.97, 7.89 (m, 4H, h), 6.92, 6.78, 6.43 (s, H, (a,b,c,d)), 5.31 (s, 1H, g), 4.96 (s, 1H, f), 3.41 -3.77 (m, 3H, e). ¹³C NMR(400 MHz, DMSO-d6) (δ, ppm): 130.8 (s, C1), 115.3 (s, C2), 146.8 (s, C3), 142.3(s, C4), 112.1 (s, C5), 129.1 (s, C6), 56.2 (s, C7), 84.8 (s, C8), 131.4 (s, C9), 128.1 (s, C10), 129.4 (s, C11), 134.2 (s, C12). ³¹P NMR (400 MHz, DMSO-d6) δ (ppm): 26.2 (s, 1P).

### C) Synthesize of Exemplary Resin of Formula (II) (II-a, VPE)

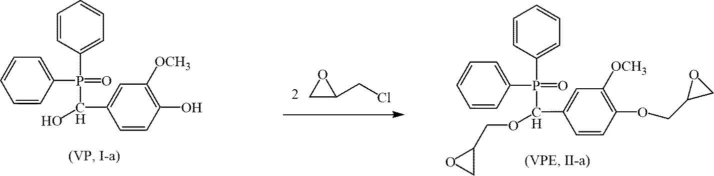 [SMILES: COc1cc(COCC2CO2)ccc1OCC1CO1]

Epichlorohydrin (15 mol) was added to a mixture of exemplary compound of Formula (I) phosphorus containing vanillin (VP, I-a) (1.5 mol) and triethylbenzylammonium chloride (TEBAC) (1.5 mol) in a three neck RB flask. The above solution mixture was agitated for 1 h at room temperature and 30 min at 80° C. After cooling down to room temperature, 1200 ml of sodium hydroxide (5 molar) and triethylbenzylammonium chloride (0.15 mol) were added slowly into the mixture and the mixture was further agitated for 30 min at 25° C. Afterwards, a two-phased mixture of ethyl acetate and distilled water was added to the above resulting solution, followed by 5 min further stirring. The extraction process was carried out two times in an aqueous phase with ethyl acetate. Organic phase containing vanillin-based epoxy resin was rinsed again with an aqueous solution of ethyl acetate and dried over manganese sulphate. Excess of ethyl acetate and epichlorohydrin was eliminated using a rotary evaporator. The resulting phosphorus containing vanillin-based epoxy resin ((3-methoxy-4-(oxiran-2-ylmethoxy)phenyl)(oxiran-2-ylmethyloxy)methyl)diphenylene phosphine oxide, (VPE, II-a) was in the form of a golden viscous liquid with a 95% yield. The molecular weight and polydispersity of VPE (II-a) were determined using GPC results as: Mn: 380 g/mol, Mw: 470 g/mol, and Mw/Mn: 1.237. ¹H NMR (600 MHz, DMSO-d6) (δ, ppm): 7.89, 7.62, 7.51 (m, 6H (j,j′,j″), 7.45, 7.31 (m, 4H, i, i′), 6.94, 6.81, 6.73 (s, H, (a, b, c), 4.16, (s, 2H, h), 3.73 (S, 3H, g), 3.88 (d, 2H, d, d′), 2.21-3.39 (m, 6H, e, e′, f, f′). ¹³C NMR(600 MHz, DMSO-d6) (δ, ppm): 131.3 (s, C1), 112.4 (s, C2), 143.1 (s, C3), 148.5(s, C4), 111.9 (s, C5), 124.2 (s, C6), 69.3 (s, C7), 51.8 (s, C8), 44.7 (s, C9), 90.3 (s, C10), 131.5 (s, C11), 130.2, 13.6 (s, C13), 129.3, 129.5 (s, C14), 56.8 (s, 1C). ³¹P NMR (600 MHz, DMSO-d6) δ (ppm): 27.5 (s, 1P).

Vanillin Epoxy (2-((2-methoxy-4-((oxiran-2-ylmethoxy)methyl)phenoxy)methyl)oxirane, (VE)) was also synthesized as a control for comparison. Synthetic procedure for the VE followed was that which was reported in synthesis of VPE.

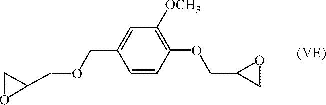

### D) Synthesize of Exemplary Compound of Formula (III) (III-a, VPU)

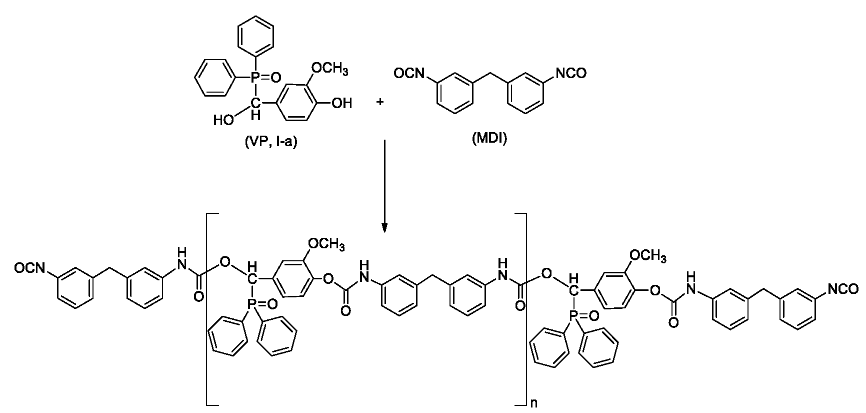

The vanillin based phosphorus containing polyurethane prepolymer was prepared in a 100-mL three-necked round bottom flask equipped with a mechanical stirrer, thermometer, and condenser. Initially, Phosphorus containing vanillin (VP) (1 mole) was charged into the dried flask, and then it was dehydrated for 2 hr at 393.15 K under the reduced pressure. When the mixture was cooled to the room temperature, dimethyl formamide (DMF), and methane biphenyl diisocyanate (MDI) (2.1 mole) were added and then the reaction between MDI and VP was allowed for 5 hr at reflux condition to obtained a NCO terminated prepolymer. A vigorous nitrogen flow was used to prevent the reaction of NCO with moisture. Excess of the DMF was completely removed under the reduced pressure, Finally, the NCO-terminated phosphorus containing vanillin based polyurethane polymer resin (VPU, III-a) was obtained in the form of pale yellow viscous liquid with 93% yield. FTIR and NMR were used to confirm the structure of synthesized resin. The molecular weight and polydispersity of VPU were determined using GPC measurements as: Mn: 984 g/mol, Mw: 1040 g/mol, Mw/Mn: 1.057. ¹H NMR (600 MHz, DMSO-d6) (δ, ppm): 9.2, 9.4 (s, 2H (d, r)), 7.7, 7.5 (s, 3H (p, p′, q, q′, q″)), 7.76, 7.03, 7.28, 7.81 (s, 5H (r, s, t, u, v)), 6.75, 6.61, 6.72, 7.03 (s, 4H, (e, f, g, h), 2.81 (d, 2H (i), 5.4, 5.9, 5.8 (s, 4H,(j, k, l, m), 3.75 (t, 3H (n), 5.9 (s, ¹H (o). ¹³C NMR(600 MHz, DMSO-d6) (δ, ppm): 133.1 (s, C1), 119.3 (s, C2), 122.5 (s, C3), 136.2 (s, C4), 151.4 (s, C5), 114.1 (s, C6), 61 (s, C7), 84.5 (s, C8), 148.2 (s, C9), 136.2 (s, C10), 118.6 (s, C11), 129.4 (s, C13), 138.1 (s, C14), 120.2 (s, C15), 42.7 (s, C16), 33.1 (s, C17), 122.1 (s, C18), 126.3 (s, C19), 128.2 (s, C20), 121.5 (s, C21), 134.6 (s, C22), 126.1 (s, C23), 160.3 (s, C24), 131.6 (s, C25), 130.1 (s, C26), 128.2 (s, C27), 134.3 (s, C28). ³¹P NMR (600 MHz, DMSO-d6) δ (ppm): 28.1, 28.5 (s, 1P).

### E) Preparation of VPE/VPU Blends

Vanillin based polyurethanes prepolymer (VPU) in the amounts of 5, 10, 15, 20, 25 and 30 wt % were mixed with vanillin epoxy resin (VPE) at room temperature using a homogenizer for 15 min at a rotational speed of 1100 rpm and labelled as VPE95, VPE90, VPE85 and VPE80, VPE 75, VPE70, respectively (Table 1). Then the pure resins and mixtures were placed in a vacuum oven for removal of air bubbles. Finally, the calculated amount of curing agent EPIKURE™ 3271 was added, and the mixing was continued for an additional 5 min before pouring the obtained compositions into a mold with standard geometries prior to thermal and mechanical tests.

TABLE 1

The formulations of VPE and VPU blends

| S.No | Sample Code | VPE (Wt %) | VPU (Wt %) | VE (Wt %) |
|---|---|---|---|---|
| 1 | VE | -- | -- | 100 |
| 2 | VPU | -- | 100 | -- |
| 3 | VPE | 100 | -- | -- |
| 4 | VPE95 | 95 | 5 | -- |
| 5 | VPE90 | 90 | 10 | -- |
| 6 | VPE85 | 85 | 15 | -- |
| 7 | VPE80 | 80 | 20 | -- |
| 8 | VPE75 | 75 | 25 | -- |
| 9 | VPE70 | 70 | 30 | -- |

### F) Preparation of VPE/FGO Nanocomposites

### (I) Preparation of Functionalized Graphene Oxide (FGO)

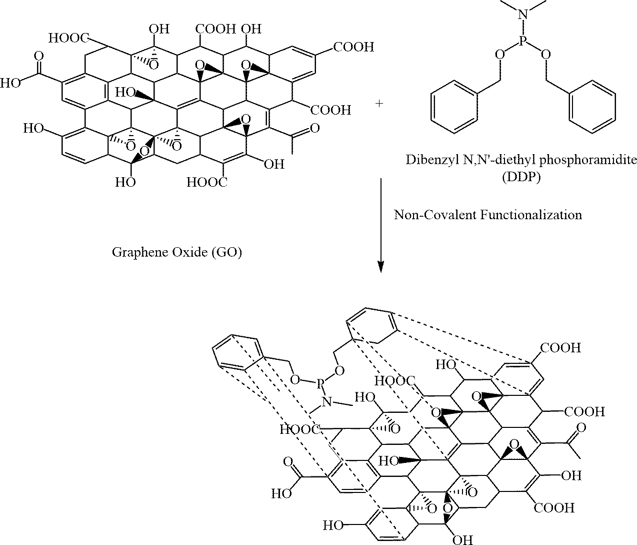

Functionalized Graphene Oxide

Prior to the preparation of VPE/FGO nanocomposites, the functionalized graphene oxide (FGO) was prepared by functionalization of dibenzyl N,N-diethyl phosphoramidite (DDP) on graphene oxide (GO). In this case, with the assistance of mild sonication, the GO was exfoliated into single-layer sheets in water. Afterwards, 20 mL of alcoholic solution of DDP (150 mg) was added dropwise into the GO suspension under constant stirring. Due to the difference between the polarizations of water and ethanol, DDP became less soluble in water. Hence, the less soluble DDP was attached to GO via strong [symbol] [symbol] interactions. Continuous penetration of DDP molecules into the GO sheets helped to achieve a more stable dispersion of FGO in water. Then, the supernatant liquid was decanted, and the residuals were rewashed again with HCl and deionized water for 5 times. The washed FGO solution was dried using an oven set at 90° C. for 24 hours to produce the powder of FGO.

### (II) Preparation of VPE/FGO Nanocomposites

Different weight fractions of the synthesized FGO were added to ethanol and sonicated until the suspension became clear with no visible particulate matter. The suspension was mixed with the exemplary VPE resin and sonicated for 1.5 h. Afterwards, the ethanol solvent was evaporated by heating the mixture on a magnetic stir plate using a teflon-coated magnetic bar for 3 h at 70° C. Furthermore, the exemplary FGO/VPE mixture was placed in a vacuum oven for 24 h at 70° C. to ensure that all of ethanol had been removed. Then, the mixture was placed in an oil bath at 90° C. and a stoichiometric amount of curing agent, diamino diphenylsulphone (DDS), was slowly added, under continuous mechanical stirring, until the solution became a homogeneous mixture. Several DSC aluminum pans were filled with the reaction mixture. The samples (~10 mg) were then cooled and stored in a freezer until required. The weight fractions of FGOs in the VPE/DDS system were 3, 5, 7 and 9 wt %, and were labelled as VPE/3%FGO, VPE/5%FGO, VPE/7%FGO, and VPE/9%FGO, respectively.

### G) Lap Shear Bonding Strength Test

Betula alleghaniensis wood (Yellow birch) strips (108 mm length×25.4 mm width×3 mm thickness) were prepared and conditioned at room temperature at ~60% relative humidity for 7 days. The bonding area (25.4 mm×25.4 mm) on the wood strip was lightly polished by sand paper. Vanillin based flame retardant VPE, VPU, their blends and the VPE/FGO nanocomposites were uniformly applied on the polished bonding area with a glass rod to reach about 0.1 mm thickness. Two pieces of adhesive-loaded wood specimens were assembled over the bonding area. By following aforesaid method, the two-layered lap-shear specimens were prepared. All the lap-shear specimens were hot pressed at 125° C. for 5 min under the pressure about 3.0 MPa.

### H) Dry Bonding Strength Test

Lap shear bonding strength of wood specimen was tested using an INSTRON 3367 according to ASTM D5868 with a crosshead speed of 13 mm/min. The wood specimens were gripped by two screw type flat-plate grips and pulled at a shear rate of 13 mm/min. The reported results were averages from five replicates of specimens.

### I) Wet Bonding Strength (cold Water and Boiling Water Test)

According to the standard PS I-95 (Voluntary Product Standard PS 1-95, 1995), the wet shear bonding strength tests were performed. For the cold water test, after the preparations of adhesive coated wood specimens, the specimens were soaked in cold water at room temperature for 24 h, and then, it was dried in a fume hood at room temperature for another 24 h prior to performing the shear bonding strength test. In boiling water test, specimens were soaked in the boiling water for 4 h, dried in an oven at 63 ± 3° C. for 20 h, and again soaked in the boiling water for 4 h; after cooling with tap water, the specimens were tested for the shear bonding strength while they were still wet. The reported results were averages from testing of five replicates of specimens.

### J) Analytical Methods

Fourier Transform Infrared (FTIR) spectra for the synthesized polymers were recorded on a Bruker Tensor 27 spectrometer (Bruker Optik GMbH, Ettlingen, Germany) by KBr pellet method within the frequency range of 4000-400 cm⁻¹.

¹H, ¹³C and ³¹P-NMR spectra of the VP, VPE and VPU were recorded on an Agilent 600 MHz (600 MHz, Agilent, Germany) NMR instrument using DMSO-d6 as the solvent.

The Gel Permeation Chromatography (GPC) was calibrated using polystyrene standards, and tetrahydrofuran (THF) flowing at a rate of 1 mL/min was used as the eluent. To analyze VPE and VPU, a salt THF solution, containing 0.25 g/L tetra-n-butylammonium bromide (TBAB) at a flow rate of 0.6 mL/min, was used as the eluent. The salt THF GPC measurements were performed using a Waters 515 HPLC equipped with a Viscotek VE 3580 RI detector and a 2500 UV/Vis detector. It was calibrated against poly (methyl methacrylate) standards.

Thermal Gravimetric Analysis (TGA) was performed vis thermal degradation studies (TGA-Q500, TA Instruments, USA). About 5-8 mg of cured resin was added to a platinum pan and heated from room temperature to 700° C. at the rate of 10° C./min under nitrogen purge.

The Gas Chromatography-Mass Spectrometry (GC-MS) analysis was conducted on a Thermo TSQ 8000 EVO Triple Quadrupole GC-MS/MS with a PTV inlet and headspace and SPME auto sampler capabilities. A silica capillary column (DB-5MS column) equipped with a quadrupole detector with pre-filter, one of the fastest, widest mass ranges was applied for the analysis. The mass spectrometer was set in an electron ionization (EI) positive/negative and chemical ionization mode at the electron ionization energy of 70 eV, Mass range: 40-600 Daltons (amu), and stability: ± 0.1 m/z mass accuracy over 48 hours. The analytes were identified by retention time and through the comparison of the mass spectra of the identified substances with references.

The thermal mechanical features of all cured samples were determined using a Dynamic Mechanical Analyzer (DMA Q800, TA Instruments, USA), operated in a multi-frequency-strain mode at a frequency of 1 Hz and an amplitude of 15 µm. The cured epoxy sample bars with a rectangular geometry (nearly 15 mm × 4 mm × 0.6 mm) were mounted on the clamp and tested from ambient temperature to 180° C. at a heating rate of 3° C./min. The storage modulus (E′) and tan δ curves as a function of the temperature were recorded and analyzed.

The lap-shear specimens were microtomed into slices to prepare the cross-sectional imaging samples. After being gold coated, the observation was carried out under a JEOL JSM-6610 Scanning Electron Microscope (SEM) (JEOL 6610LV, Seal Laboratories, El Segundo, CA, USA at 15 kV).

UL-94 vertical burning tests were conducted according to ASTMD2863-97 with sample dimensions of 80 mm × 6.5 mm × 3 mm. This test measures the self-extinguishing time of the vertically oriented test specimen. The top of the test specimen is clamped to a stand and the burner is placed directly below the specimen. The test evaluates both the burning and afterglow times and dripping of the burning test specimen. In the limiting oxygen index test (LOI), The LOI values were measured according to ASTM 2863-17a standard and the sample dimension was 130 mm × 6.5 mm × 3 mm. The sample was held vertically in the glass chamber, where there is a controlled flow of oxygen and nitrogen. The top end of the sample was ignited and time to burn 50 mm of the sample was measured. The test was repeated under various concentrations of oxygen and nitrogen to determine the minimum concentration of oxygen needed for burning the sample.

Each specimen was tested under a constant heat flux of 50 kW/m² in a cone calorimeter in accordance with ISO-5660-1 (ASTM E1354) standard with the sample size of 100 mm × 100 mm × 3 mm. The products of combustion were captured and analyzed to determine, among other parameters, heat release rate, total heat release rate, effective heat of combustion, smoke obscurity and production, and toxic gas concentrations (ex: CO₂, CO, etc..).

### B. Results and Discussion

### A) FTIR and NMR Analysis

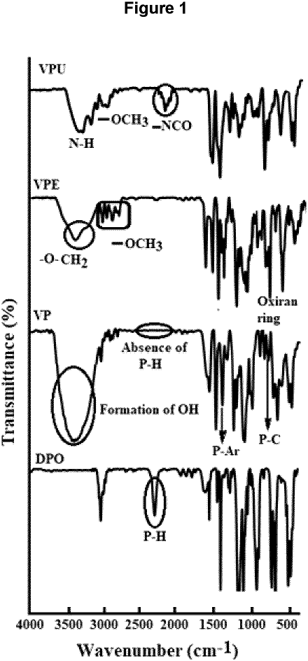

The FTIR spectra were used to confirm the molecular structure of the synthesized phosphorus containing vanillin (VP, I-a), phosphorus-vanillin based epoxy (VPE, II-a) and polyurethane resin (VPU, III-a) as shown in FIG. 1. The FTIR spectrum of diphenyl phosphine oxide (DPO) showed the presence of an absorption band at 2352 cm⁻¹ that was attributed to P-H group. The absence of absorption peak at 2352 cm⁻¹ and the strong peak noted at 3425 cm⁻¹ attributed to the OH group formation in the FTIR spectrum of VP indicated that the reaction happened between DPO and Vanillin^{[39,} ^{40]}. The FTIR spectrum of phosphorus containing vanillin-based epoxy resin (VPE) is also shown in FIG. 1. The key functional group of this compound is the oxirane which has an absorption band in 918 cm⁻¹, confirming the formation of epoxide rings. The bands appeared at 2875 cm⁻¹ and 1657 cm⁻¹ represent the aliphatic and aromatic -CH₂ groups, respectively. The FTIR spectrum of VPU showed some clear changes from the FTIR spectra of VP. A strong absorption band noted at 3302 cm⁻¹ corresponding to the characteristic of the N-H group and an absorption peak at around 1731 cm⁻¹ due to carbonyl groups of urethanes were observed, representing the presence of urethane structures in the adhesive. Besides, a clear strong absorption band at 2278 cm⁻¹ was also noted, which indicated the presence of excess —NCO groups in the VPU adhesive^{[41]}. The appearance of expected characteristic structures in this VPU resin confirmed the successful synthesis of polyurethane prepolymer from VP.

Furthermore, the characteristic protons peaks at 2.21-3.39 ppm in the ¹H-NMR spectrum also confirmed existence of epoxy group^{[25]} in VPE. ¹H-NMR spectrum of VPU also had the chemical shift at 9.2, 9.4 ppm which is assigned to proton present in the urethane linkage^{[36]}. In addition, the chemical shift and integral area of all mentioned ¹H NMR peaks were in excellent agreement with the target product . Moreover, the ¹³C-NMR in showed that the carbon resonances matched well with the expected structure in VP, VPE and VPU. In the ³¹P NMR spectra, VE, VPE and VPU, showed a single sharp resonance peak at 26.5, 27.5 and 28.1 ppm, respectively^{[27]}, confirming the functionalization of DPO on vanillin. All these results indicated the successful synthesis of VE, VPE and VPU with the intended molecular structures.

FTIR spectra confirming the molecular structure of the VP, VPE, VE, and VPE/FGO nanocomposites were also carried out in wavelengths of 4000-400 cm⁻¹. The FTIR spectrum of DPO showed the presence of an absorption peak at 2352 cm⁻¹ attributed to P-H group. The absence of the absorption peak at 2352 cm⁻¹ and the strong peak noted at 3425 cm⁻¹ in the FTIR spectrum were attributed to the OH group formation in VP indicating that the reaction occurred between DPO and Vanillin. The FTIR spectrum of phosphorus containing vanillin-based epoxy resin (VPE) is also shown in FIG. 1. The most evident functional group in FTIR spectrum of VPE is the oxirane which has an absorption peak at 918 cm⁻¹, confirming the formation of epoxide rings. The peaks appeared at 2875 cm⁻¹ and 1657 cm⁻¹ represented the aliphatic and aromatic -CH₂ groups, respectively.

In the FTIR spectra, the presence of phosphorus in the VPE backbone was confirmed by the characteristic absorption peaks at 3446(O-H), 1429(Ph), 1130(P=O), 733 and 711 cm⁻¹(P-Ph), and the absence of the distinctive absorption at 2352 cm⁻¹ for P(O)—H that was present in neat DPO. Functionalization of the flame-retardant group on GO was also confirmed by the FTIR spectrum. The FTIR spectrum of GO showed some typical absorption peaks of oxygen-containing groups: O-H stretching vibration (3418 cm⁻¹), C=O stretching vibration (1732 cm⁻¹), C═C or H₂O vibration (1625 cm⁻¹), and C-O stretching vibration (1230 cm⁻¹)^{[38]}. After being functionalized by DDP, a slightly decreased intensity for the peak at 3418 cm⁻¹ was observed in the spectrum of FGO, suggesting that functionalization of GO by DDP mostly occurred by non-covalent strategy. Additionally, the distinctive absorption peaks for P-N stretching appeared at 1085 cm⁻¹. In the FTIR spectra for thermally cured neat VE, VPE, VPE/FGO nanocomposites, the peak at 918 cm⁻¹ was nearly absent in all cured systems, indicating the successful opening of the oxirane ring upon the curing reactions. The opening of the oxirane ring was further supported by the broadened peak noted at 3500 cm⁻¹, which corresponded to the formation of hydroxyl groups during the ring opening polymerization

### B) DMA Analysis

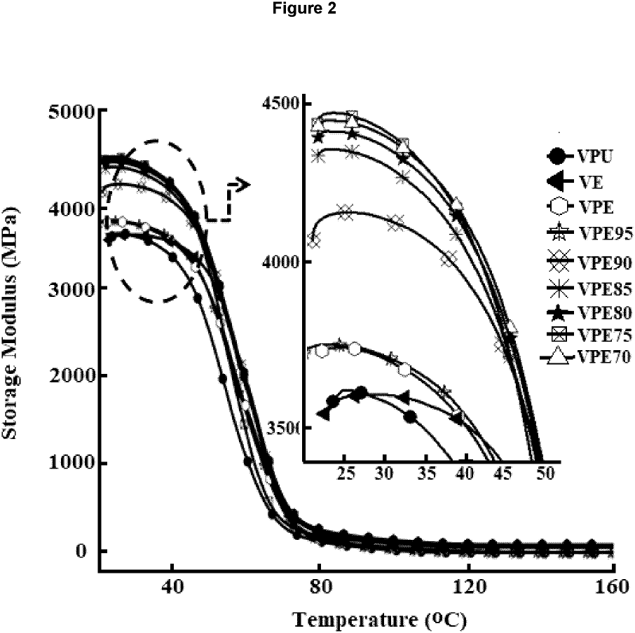

Dynamic Mechanical analysis was used to understand structure and property relationship between PU and epoxy and their blends. In this study, the mechanical properties of blends are found to be superior to the neat polymers (VE, VPE and VPU) alone. The plots of storage modulus (E′) and loss factors (Tan δ) as a function of temperature are shown in FIG. 2. From FIG. 2 it is clear that the storage modulus (E′) and Tanδ decreased gradually with the increase in temperature first and then sharply dropped due to the transition of polymers from glassy state to rubbery state at above glass transition temperatures. Compared with neat resin samples (VE, VPE and VPU), the storage modulus of VPE95, VPE90, VPE85 and VPE 80 blends increased gradually and the values (@30° C.) were 3.67, 3.69, 4.12, 4.33 and 4.36 GPa respectively, There was a slight drop in the mechanical strength of VPE with 25 and 30 wt.% of VPU addition and the values were reported as 4.31 and 4.29 GPa, respectively (FIG. 2a) . Therefore, it was decided to focus studies on VPU content up to 20% (i.e. VPE80) only to avoid having negative effects associated with excess amount of VPU on the mechanical and flame retardant properties of the blends. Excess VPU in VPE could prohibit the ring opening of oxirane in VPE, subsequently the unreacted oxirane ring may lead to poor mechanical performance^{[44]}. However, VPE with 20% of VPU addition showed that VPU caused the enhancement in the capacity of epoxy polymer to support mechanical constraints with recoverable viscoelastic deformation. It might also be attributed to the presence of intermolecular hydrogen bonding between the hydroxyl groups in epoxy and isocyanate groups in VPU for forming interpenetrating networks. Also it was likely that each new urethane and allophanates unit became a new branching point, to potentially create more crosslinking. Moreover, the VPE/VPU blends had better compatibility with the wood substrate than that of VPE and VPU system alone. From FIG. 2b the Tanδ transition peaks for all blends shifted to lower temperatures when compared to neat VPE, but higher temperatures than neat VPU. Previous studies^{[45,} ^{46]} have shown that when two different polymers were mixed, the dynamic mechanical behaviour showed two distinct transitions, indicating the incompatibility between the two polymers. But for all VPE/VPU blends developed in this study, Tan δ had only a single transition peak, After mixing the VPE with VPU, the individual polymer property was changed, in which the lower Tg component is shifted to a higher temperature, while the higher Tg component is shifted to a lower temperature to result in a single transition. This also suggested that the VPE had good compatibility with the transition domain of polyurethane. Thus, the incorporation of VPU into VPE resulted in final cured blended resin having better mechanical properties than the neat resins.

For instance, Wang et al.^{[47]} prepared a synthesized formyl group-containing vanillin-based monoepoxide and a diamine via in situ formation of the Schiff base structure and epoxy network. The maximum storage modulus value achieved in that study was 2.11 GPa, which was comparable with DGEBA based epoxy but lower than what has been obtained in our study . Xu et al.^{[48]} also used vanillin to synthesize a Schiff base epoxy thermoset, they obtained a maximum storage modulus value of 2.65 GPa, which was also higher than that of DGEBA but lower than what is obtained here. The higher storage moduli of the blends were the result of the level of cross-link density and rigidity of the molecular chain structure of IPN’s formed by VPE and VPU.

### C) Lap Shear Bonding Strength

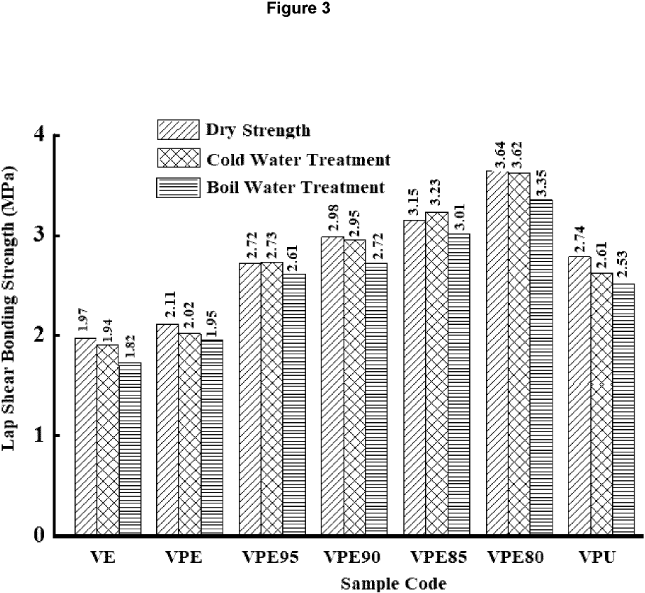

The average lap shear bonding strengths (dry strength and wet strength after cold water treatment and boiling water treatment) of the neat VE, VPE, VPU and the VPE/VPU blends are shown in FIG. 3. As shown in FIG. 3, the dry and wet lap shear bonding strength values for all specimens were similar with little variations under these testing conditions, showing excellent wet adhesion properties of these novel adhesives. The average dry lap shear bonding strength increased to 2.11, 2.72, 2.98, 3.15, 3.64 and 2.74 MPa for the VPE, VPE95, VPE90, VPE85, VPE80 and VPU, respectively, compared to VE. Irrespective of different test conditions, the VPE/VPU blends revealed an surprising enhancement in lap shear bonding strength compared with the neat VPE and VPU adhesives. The results showed that the adhesive strength for wood substrate was the highest for the VPE/VPU blends and the bonding strength increased with the increasing addition level of VPU to VPE. This may be attributed to the presence of a large number of end functionality of the branched polymer along with other polar groups present in the VPE/VPU system.

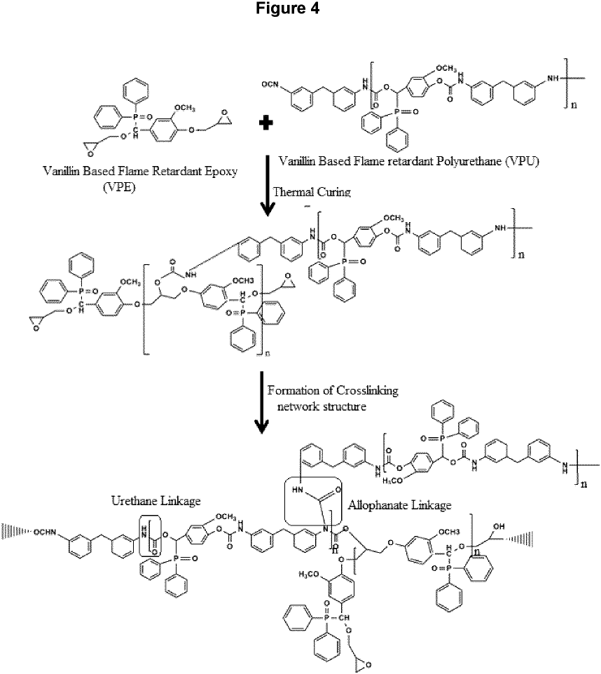

In general, the adhesive performance on wood depends upon factors, such as the smoothness of wood substrate, presence of wood extractives, and pH etc.,^{[42]} The interactions of the polar groups present in the adhesives and wood substrates are through hydrogen bonding, polar-polar and polar-induced-polar interactions, or/and chemical bond formation^{[43]}. Interestingly, in this study, it was found that the highest lap shear bonding strength was found forVPE80 and, without being limited by theory, it was justified that when increasing VPU addition to VPE, the excessive of N═C═O group in VPU reacted to form isocyanurates, biurets and allophanates thus giving stronger mechanical strength to the cured polymer products (FIG. 4). It may also promote reaction of isocyanate with hydroxyl groups to form a more rigid three-dimension networking by reacting with naturally occurring hydroxyl groups in the wood polymers. Although, it is anticipated that under different testing conditions the remaining isocyanate groups could undergo post-curing during the cold water and boiling water soaking treatments. Remarkably, there was no change in bonding strengths after the cold water soaking treatment compared to dry bonding strength. The change observed for the boiling water treatment may be due to the difference in the testing method. However, failure modes for both cold and boiling water soaked specimens were all wood substrate failure, similar to the case for dry bonding strength test. More interestingly, shear bonding strength values for all specimens were similar with little variations under these three testing conditions (FIG. 3). From the bonding strength testing results, VPE/VPU ratio of 80:20 was found to produce good mechanical strength with a higher resistance to water.

In addition, the average bonding lap shear strengths (dry strength, cold water treatment, and boiling water treatment) of the neat VE and exemplary VPE epoxides and their VPE/FGO nanocomposites are shown in Table 2. It is clear that lap shear bonding strength values for all specimens were similar among the three different testing conditions, indicating excellent wet bonding strengths of all samples. Irrespective of the test condition, after adding FGO, the resulting nanocomposites revealed a significant enhancement in lap shear bonding strength compared with the neat VE and exemplary VPE epoxy resins. The results also show that the lap shear bonding strength increase up to 7 wt% of FGO addition. There was a slight drop in the lap shear bonding strength of exemplary VPE with 9% of FGO addition. It had been shown by previous studies that the viscosity of the epoxy resin increased with the increasing percentages of FGO. Hence, the epoxy with higher loadings of FGO (after 7%FGO) could not penetrate into the substrate as much in the same amount of depth as the epoxy without FGO.

TABLE 2

Lap Shear Bonding Test Results for VE, VPE and VPE/FGO nanocomposites

| Sample Code | Lap Shear Bonding Results (MPa) | | |
|---|---|---|---|
| | Dry Strength | Cold Water Treatment | Hot Water Treatment |
| VE | 1.97 | 1.94 | 1.82 |
| VPE | 2.11 | 2.02 | 1.95 |
| VPE/3%FGO | 2.34 | 2.27 | 2.01 |
| VPE/5%FGO | 2.76 | 2.78 | 2.42 |
| VPE/7%FGO | 3.12 | 3.13 | 2.65 |
| VPE/9%FGO | 2.65 | 2.43 | 2.32 |

Results from the failure mode analysis of the lap shear test specimens further supported the trend observed for the lap shear bonding results for the neat VE and exemplary VPE epoxides and their VPE/FGO nanocomposites. The cold water-soak test method required the wood specimen to be dried (after soaking) prior to the testing, but in the case of boiling water treatment the specimen was tested in the wet state. As a result, failure mode for dry strength test and cold water soaked and dried specimens were wood substrate failure. However, the boiling water-soaked specimen’s failure mode was mostly by failure in the adhesive layer. The bonding strength for dry and cold-water soaking test was limited by the cohesive strength of the wood substrate itself. Overall, FGO enhanced the lap shear bonding strength of the neat resin systems and the composite showed a higher resistance to water penetration.

### D) SEM Analysis

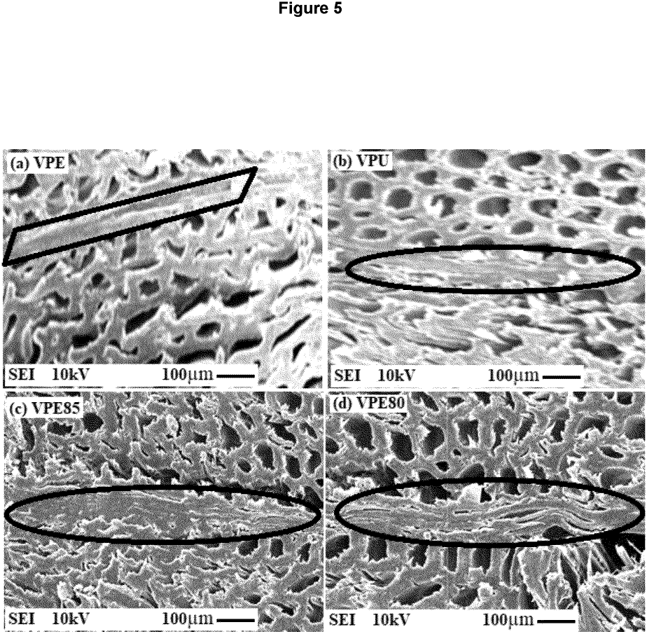

Failure modes of the adhesives were studied by SEM analysis of the bondline of lap shear specimen. For VPE and VPU, FIG. 5 showed a thin continuous bondline. However, the bondline was not that evident. Due to the low molecular weight of both VPE and VPU, these resins would penetrate too deeply into the wood substrate. Over penetration would lead to starvation of the adhesive at the bondline ^{[49]}. Therefore, both VPE and VPU have been observed to have thinner bondlines in the lap shear specimen. Whereas the VPE/VPU blends, like VPE85 and VPE80, formed a thicker bondline. It was found that the addition of VPU to VPE led to an increase in the crosslinking density of the resulting cured resins. The improved bondline retention for stress transfer between the bonding surfaces and higher adhesion due to better adhesive and substrate interactions led to higher mechanical properties of the final cured resins. Since strong adhesion strength between the adhesives and the substrate surpassed the cohesive strength of the wood substrate itself, as a result, wood substrate failure appeared as the dominating failure mode during the bonding strength testings.

Surface morphology of GO and FGO and the dispersion of FGO in VPE were also characterized by the SEM analysis. The surface of FGO had a higher roughness compared to that of GO. The EDX mapping showed intense signals of C, N, P and O for FGO confirming the functionalization. The absence of other elemental signal indicated the high purity of FGO, which was achieved by repeated cycles of water and methanol washes to remove any unwanted ions. Due to the good affinity of H+ and CI⁻ ions towards water, these ions were removed from the prepared FGO during washing.

The level of dispersion of FGO in the epoxy matrix was also examined by SEM. The surface morphology of VPE was considerably smoother than that of the VPE/FGO nanocomposites. The roughness of the surfaces of the VPE/FGO nanocomposites increased upon the addition of FGO due to the dispersion of the graphene sheets throughout the matrix. In addition, FGO were well exfoliated with little visible agglomerates. It also showed that the homogenously dispersed FGO were strongly bonded with the epoxy matrix without any debonding or pull-out of the FGO nanolayers. While not wishing to be limited by theory, the strong bonding could be the result of covalent bond formation between the epoxy matrix and FGO sheets during the curing process. Improved dispersion and bonding of the FGO sheets would significantly enhance the final mechanical properties of the composites.

### E) XRD Analysis

The XRD analysis was carried out for GO, FGO, VPE, and VPE reinforced with different weight percentages of FGO. The typical diffraction peak at 2θ = 12.1° of GO was the 002 reflection peak, which was equivalent to an interlayer spacing of about 0.34 nm. When compared to GO, FGO only had a weak diffraction peak at 2θ = 33.2°, confirming a larger interlayer spacing (0.93 nm) in FGO. There was a shift in the peak intensity of FGO filled VPE epoxy nanocomposites from 2θ=32.4° for FGO to 2θ = 23.3° for the composites. The intensity of the peaks at this 2θ increased significantly with an increasing amount of FGO. The shift of the intensity peak towards a lower angle indicated that the interplanar spacing among the graphite platelets of FGO decreased, suggesting that there was mixed intercalated and exfoliated FGO platelets in the epoxy nanocomposites. The decrease in the interplanar spacing was higher with a higher FGO content in the system, implying that the systems with a lower level of FGO loading had more exfoliated morphologies. When compared to VPE/FGO, the neat VPE epoxy resin demonstrated a broad diffraction peak centered at 2θ ≈ 20° originated from the scattering of the cured epoxy network, indicating the amorphous nature of the polymer. It could be seen that all VPE/FGO composites showed a similar diffraction pattern, due to the homogenous dispersion and complete exfoliation of FGO in the VPE epoxy matrix. Therefore, these results indicated that non-covalent bonding between VPE and FGO had resulted in significant structural changes in the carbon lattice.

### F) Thermal Behaviour and Flame Resistances

### I) TGA and GC-MS Studies

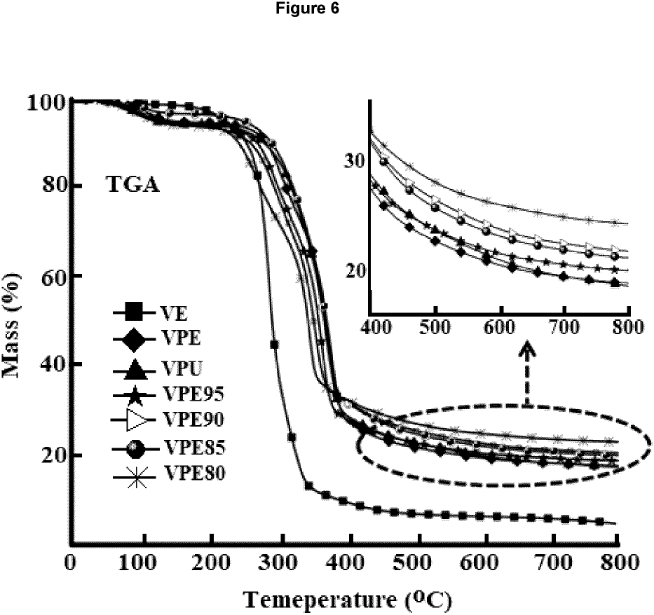

The TGA studies were carried to evaluate thermal stability of VPE, VPU and VPE/VPU blends. It was found that the thermal stability of all blends were significantly improved by the introduction of VPU into the VPE resin. The initial onset degradation (Ts) temperatures and maximum (Tmax) temperatures of the first and second weight loss processes are listed in Table 3. Thermal decomposition behaviour of phosphorus free vanillin epoxy (VE) exhibited a single stage of degradation, whereas thermal degradation response of VPE, VPU and their blends occurred in the temperature ranges of 200-310 and 310-410° C. via a two-step process (FIG. 6).

TABLE 3

Thermal degradation parameters for the cured VE, VPE, VPU and their blends

| Samples | Ts (°C) | Td (5%) (°C) | Tmax (°C) | | Td (50%) (°C) | TE (°C) | Char (%) (600° C.) |
|---|---|---|---|---|---|---|---|
| | | | I | II | | | |
| VE | 221 | 247 | - | 327 | 295 | 358 | 7.2 |
| VPE | 250 | 266 | 318 | 372 | 361 | 406 | 20.3 |
| VPU | 262 | 271 | 304 | 379 | 368 | 408 | 21.2 |
| VPE95 | 252 | 269 | 296 | 373 | 361 | 395 | 24.5 |
| VPE90 | 244 | 264 | 285 | 368 | 360 | 407 | 25.7 |
| VPE85 | 231 | 263 | 283 | 354 | 348 | 385 | 26.1 |
| VPE80 | 221 | 257 | 271 | 350 | 345 | 373 | 28.4 |

However, the initial on-set temperature and Tₘₐₓ of the first and the second-stage degradation of the VPE/VPU blends decreased with increasing VPU content, without being bound by theory, this was attributed to the decomposition of oxygen-containing groups, and the oxidation of the char residue. It could also be caused by the breakage of unstable chemical bonds, such as phosphorus-containing groups (P-O-C and P-C bonds) in DPO at lower temperatures^{[50]}. The degraded phosphate group contributed to the formation of the compact char residue, which protected the sample from further thermal degradation. Even though the blends showed a reduced thermal stability in Tₘₐₓ for the initial and second stages, the char residues of VPE95, VPE90, VPE85 and VPE80 were increased to 24.5, 25.7, 26.1 to 28.4% respectively at 600° C. This was due to the formation of additional char residues from the first degradation process slowing the release of pyrolysis products and potential formation of allophanate and biuret linkages during cross-linking reactions in VPU to give more char residues (FIG. 4). However, the urethane linkages present in the VPU decomposed at a considerably moderate temperature, whereas the aromatic moiety of diisocyanate decomposed at very high temperature in this case^{[51]}. The detailed char residue mechanism of degradation products was studied in GC-MS studies discussed in the next section.

TGA studies were also performed to evaluate the thermal degradation properties of the neat VPE and FGO/VPE nanocomposites. Neat VE underwent a single stage thermal degradation process in the temperature range of 250 to 380° C., which was due to thermal degradation of neat VE polymer network. Meanwhile, DTG curve of thermally cured VPE showed multistage degradations overlapping with each other, indicating that the second thermal degradation process of VPE started before the completion of the first degradation process. Incorporation of FGO had no effect on the overlapping nature of the degradation stages of the cured VPE, but the thermal degradation onset temperature shifted toward lower temperatures compared to those of neat VPE, which was attributed to the increase of labile oxygen functional groups on the surface of FGO. However, the char value was increased after the addition of FGO, which was due to the flame-retardant groups grafted on FGO promoted the char formation. Therefore, the increase in char residue could form a barrier to protect the nanocomposites from further oxidative degradation.

In general, the initial stage of thermal degradation of phosphorus-nitrogen containing FGO additives could catalyze the degradation of polymers to form a shielding char layer. The char yield at 600° C., i.e. the residue percentage, of pure VPE was approximately 20.3%. VPE/9%FGO samples exhibited the highest char residues (24.1% @ 600° C.) than other FGO addition levels (3, 5 and 7 wt%) indicating that the catalytic charring effect of P—N groups present in the FGO was the main reason. The formation of high char residues during combustion decreased the release of combustible gases and inhibited the mass and heat transfer between the condensed phase and the gaseous phase, thus slowing down the heat release rate. Besides, the char layer could shield polymers from flame in the early stage of ignition. Hence, even though FGO reduced thermal stability in the initial stages, the char residue increased with an increasing FGO content up to 24.1% @ 600° C.

### II) GC-MS Studies of Flame Retardant Mechanism

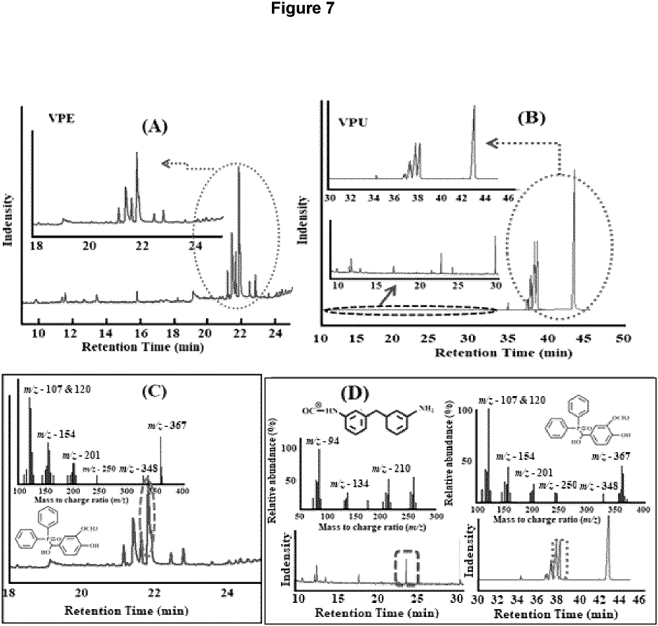

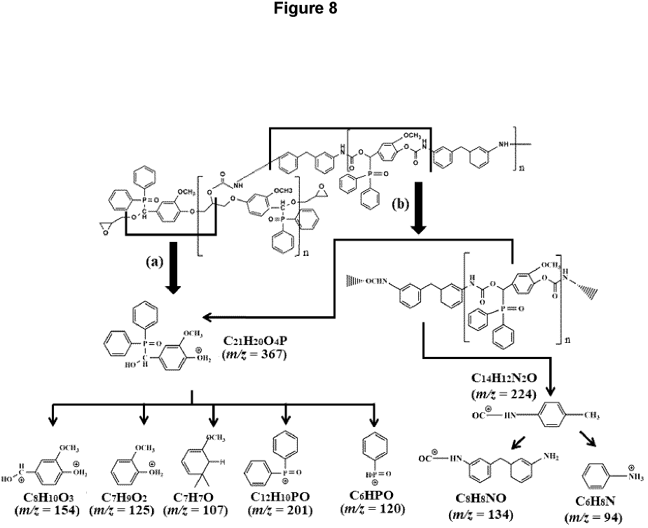

In general, the aromatic structure formed during the degradation process plays a role in achieving self-extinguish and flame retardancy characteristics during combustion^{[52]}. In order to understand the flame retardant mechanism of these resins, GC-MS spectra of decomposition products of VPE and VPU that consisted of a number of different chemical species, including several aromatic peaks were obtained (FIG. 7). The most abundant products were identified by the GC-MS analysis. The mass spectra corresponding to the GC peaks are presented in FIGS. 7C and 7D. The decomposition products based on the molecular weights of the fragment ions together for VPE and VPU are labelled and presented in FIG. 8.

From FIGS. 7C and 7D, the mass spectra of corresponding GC graph for VPE and VPU clearly showed a new strong peak at 367 m/z corresponding to C₂₁H₂₀O₄P (VP). Also, peaks at 154 m/z (for C₈H₁₀O₃), 107 m/z (for C₇H₇O), 201 m/z (for C₁₂H₁₀PO) and 120 m/z (for C₆HPO) could be assigned to the fragment ions that mainly originated from the degradation of the DPO segment present in both VPE and VPU as shown in FIG. 8. As well as some other strong peaks at 210 m/z (for C₁₄H₁₂NO), 134 m/z (for CsHsNO), and 94 m/z (for C₆H₈N) were indicative of diphenyl methane diisocyanate (DMI) present in the VPU backbone. Moreover, some fragment ions recombined to form some new products under high temperature conditions; for instance, the recombination between benzene and aniline generated carbazole (250 m/z), and the carbazole and benzene reconstituted to produce a few of polycyclic aromatic hydrocarbons (348 m/z)^{[53]}. Without being bound by theory, based on the results of volatile fragmented ions, the following charring mechanism can be proposed to explain the enhancement in flame retardancy and thermal degradation performance. The phosphorus containing DPO segments, mono aromatic structure present in the vanillin segments, and hydroxyl groups formed during opening of oxirane ring in the VPE were firstly fractured and detached from the main molecular chain^{[54]}. And it was further degraded to form numerous low molecular weight aromatic compounds (FIG. 8a). These compounds were the major products formed during the degradation process leading to higher char residues. That was beneficial to enhance the char yield. Whereas in the degradation process of the molecular backbone of DPO and 4, 4′-diaminodiphenyl methane (DMI) segments in the VPU system, the biphenyl radical were released (FIG. 8b). The produced biphenyl radical intermediates could randomly undergo combination, cross-linking, and rearrangement and dehydrogenation reaction to finally form the stable rich aromatic char layer^{[55]}. As a result, even though the VPE/VPU blends had a lower thermal stability in the initial and second stages, the char residues still increased with an increasing VPU content. With the increasing concentration of VPU in VPE, the concentration of aromatic hydrocarbons became higher in the decomposition product mixture. In addition, the incorporation of VPU to VPE increased the cross-linking density, which brought polymer backbones closer together and thereby made the products to be thermally more stable and higher in flame retardancy^{[56]}. Therefore, the VPE/VPU blends had excellent thermal stabilities with a high amount of char residues. Generally, a higher char yield could result in a better flame retardancy. Because the formed char residue could serve as a protective layer to inhibit the transport of heat and oxygen and protect the resin matrix from further degradation.

To investigate the flame-retardant mechanism, decomposition products obtained from VPE during combustion were studied by the GC - MS technique. The mass spectra of the corresponding GC graph for VPE and DDS clearly showed a new strong peak at 367 m/z corresponding to C₂₁H₂₀O₄P (VP). Also, peaks at 154 m/z (for C₈H₁₀O₃), 107 m/z (for C₇H₇O), 201 m/z (for C₁₂H₁₀PO) and 120 m/z (for C₆HPO) could be assigned to the fragment ions that mainly originated from the degradation of the DPO segment present in VPE. As well as some other strong peaks at 304 m/z (for C₁₆H₂₀N₂SO₂), 235 m/z (for C₁₂H₁₃N₂SO₂), 140 m/z (for C₆H₄SO₂), 166 m/z (for C₁₂H₈N), 93 m/z (for C₆H₇N) and 78 m/z (for C₆H₆N) were indictive of diamino diphenyl sulphone (DDS) curing agent. Moreover, some fragment ions recombined to form new products under high temperature conditions; for instance, the recombination between benzene and aniline generated carbazole (250 m/z), and the carbazole and benzene reconstituted to produce a few polycyclic aromatic hydrocarbons (166 m/z).

### III) Flame Retardancy Performance of the Cured Resins

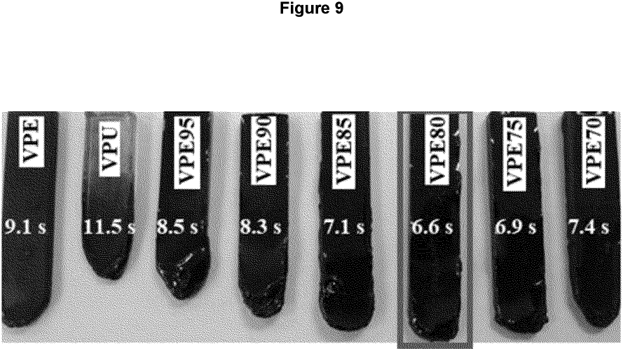

The flame retardant properties of all cured resins (VE, VPE, VPU, VPE95, VPE90, VPE85, VPE80, VPE75 and VPE70) were evaluated by UL-94 vertical burning test and results are summarized in Table 4. Representative digital photos taken after the combustion process to illustrate burning behaviour of VPE, VPU and their blends were presented in FIG. 9. As shown in FIG. 9, VPE80 exhibited excellent fire resistance. For VPE80, fire was quenched shortly (about 6.6 s) after the removal of the ignition source, demonstrating self-extinguish charcteristics and reaching UL-94 V0 rating during vertical burning. While increasing the VPU content to about 25 and 30 wt.% in VPE (i.e. VPE75 and VPE70), negatively affect the UL-94 test performance. These observations were consistent with the DMA studies that showed an decrease in storage modulus for VPE75 and VPE70 samples. As a result, VPE75 and VPE70 samples were not included in the LOI tests.

VE was highly combustible with a LOI value of only 21.4% due to the absence of phosphorous element. VE sample failed the UL-94 test because the sample was unable to self-extinguish once ignited. Moreover, a large amount of black smoke was released during the combustion process accompanied by dripping, this would not only be detrimental for the escape of fire victims, but also could easily cause a secondary fire^{[57]}.

TABLE 4

LOI testing results and UL-94 rating of the cured resins

| Sample Code | Time to Flame Subjection (s) | Flame seen after ignition (s) | UL-94 Rating | Cotton Ignition | LOI (%) |
|---|---|---|---|---|---|
| VE | 20 | 43 s (completely Burned) | Unrated | N/A | 21.4 |
| VPE | 20 | 9.1 | V-0 | No | 26.6 |
| VPU | 20 | 11.5 | V-1 | No | 26.7 |
| VPE95 | 20 | 8.5 | V-0 | No | 28.3 |
| VPE90 | 20 | 8.3 | V-0 | No | 27.3 |
| VPE85 | 20 | 7.1 | V-0 | No | 28.8 |
| VPE80 | 20 | 6.6 | V-0 | No | 29.6 |
| VPE75 | 20 | 6.9 | V-0 | No | No Data |
| VPE70 | 20 | 7.4 | V-0 | No | No Data |

The LOI values of all other cured phosphorus containing resins, VE, VPE, VPU, VPE95, VPE90, VPE85 and VPE80, were 21.4, 26.6, 26.7, 28.3, 27.3, 28.8 and 29.6%, respectively. And all the cured phosphorus containing resins achieved a UL-94 V-0 rate without dripping, indicating that phosphorus containing vanillin based VPE, VPU and theirs blends possessed excellent flame retardant properties. The flame retardancy of the cured blends was mainly attributed to both the presence of phosphorus and interpenetrating network formed due to crosslinking reactions between VPE and VPU between hydroxyl groups of epoxide oligomer and isocyanate groups^{[58]}. Furthermore, the formation of char residues during combustion reduced the efficiency of heat and oxygen transport that further promoted anti-flame properties. This observation was also consistent with the results obtained by the TGA and GC-MS measurements on char residues.

LOI and UL-94 tests were also conducted to investigate the flame-retardant properties of VE, VPE and VPE/FGO nanocomposites. Corresponding data are presented in Table 6 below. VE was a highly flammable material with a low LOI value (21.4%) and did not achieve any rating in the UL-94 vertical burning test. Due to the phosphorus present in the backbone of VPE, the LOI value of VPE increased to 26.6% and VPE passed V-0 rating in the UL-94 test. Furthermore, The LOI values for VE/3%FGO, VE/5%FGO, VE/7%FGO, and VE/9%FGO were 27.1%, 27.3%, 28.2%, and 29.1%, respectively and all samples achieved a V-0 rating. These results indicated that VPE and VPE/FGO nanocomposites possessed excellent flame retardancy when compared to vanillin epoxy without phosphorus (VE).

The blowing-out effect was noted for the cured VPE and VPE/FGO nanocomposites during the UL-94 test. Such an effect was not observed for the neat VE. In the case of VE, after the first 20 s ignition, the VE specimen burned rapidly, and the fire spreaded very fast from the igniting source to the clamping end. The sample continued to combust until the whole sample burnt out obtaining no UL-94 rating. While in the case of VPE and VPE/FGO, fire on the samples was self-quenched after removing the ignition source. In addition, when the igniter was removed, the flame was rapidly blown out by the airflows from the igniting end. This was due to the so-called blowing-out effect [66]. The airflows were caused by the jet of pyrolytic gases from the char layer. The combination of phosphorus and nitrogen atom present in the DDP played a role in increasing flame retardancy.

### IV) Cone Calorimetry Test

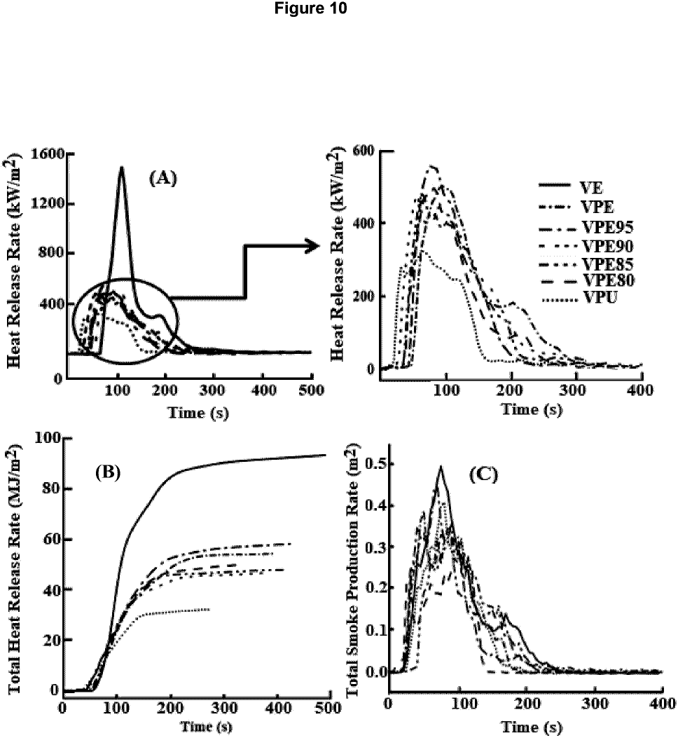

Cone calorimeter is a useful bench-scale tool for analysing combustion behaviours and fire safety of materials. FIG. 10 showed the time based evolution of heat release rate (HRR), total heat release (THR) curves and total smoke production rate (TSP). The measured values for average heat release rate (Avg HRR), peak heat release rate (Pk HRR), average effective heat of combustion (Avg EHC), CO₂ yield, and CO yield of VPE, VPU blends and VPE/FGO nanocomposites are presented in Table 5 and Table 6. Results indicated that all VPE, VPU and their blends exhibited excellent thermal and flame-retardant properties. The assessment by cone calorimetry test demonstrated that when compared to phosphorus free vanillin epoxy (VE) control resin, the Avg HRR, Pk HRR, Avg EHC, Avg CO and Avg CO₂ for VPE80 were reduced to 59.92%, 32.28%, 52.84%, 78.94% and 50.26%, respectively. These test results showed the processes of forming compounds of Formula (II) and Formula (III) and the IPN of the application is a promising way to achieve high performance epoxy and polyurethane resins and their blends with improved flame retardancy and mechanical properties simultaneously.

HRR peak (Pk HRR) was usually considered to be the key parameter for evaluating fire safety using cone calorimetry data. FIG. 10A showed that phosphorus free vanillin epoxy (VE) burn very fast after ignition and reached a sharp peak according to the HRR curve, whereas for phosphorus containing resins, the values of HRR showed a great decline. The decrease in TSP in FIG. 10C also suggested that the phosphorus functionalized systems reduced smoke generation during burning. It could be obviously seen that Avg HRR, Pk HRR, Avg EHC, Avg CO release rate and Avg CO₂ release rate were also decreased for VPE and VPU from Table 5. These observations were consistent with the LOI and UL94 burning test results.

TABLE 5

Cone calorimetry data of cured VE, VPE, VPU and VPE/VPU blends

| Sample Code | Avg HRR (kW/m²) | Pk HRR (kW/m²) | Avg EHC (MJ/kg) | Avg CO (kg/kg) | Avg CO₂ (kg/kg) | Mass (%) @600° C. TGA |
|---|---|---|---|---|---|---|
| VE | 144.73 | 1499.00 | 24.62 | 0.19 | 1.87 | 9.5 |
| VPE | 137.68 | 509.00 | 12.96 | 0.17 | 0.92 | 20.5 |
| VPU | 117.45 | 327.00 | 14.78 | 0.13 | 1.13 | 19.5 |
| VPE95 | 124.70 | 567.00 | 13.96 | 0.17 | 0.97 | 20.8 |
| VPE90 | 121.50 | 504.00 | 13.88 | 0.17 | 0.98 | 22.8 |
| VPE85 | 115.63 | 490.00 | 13.37 | 0.16 | 0.91 | 22.16 |
| VPE80 | 86.74 | 484.00 | 13.01 | 0.15 | 0.94 | 24.9 |
| Decreased to | 59.92% | 32.28% | 52.84% | 78.94% | 50.26% | |

TTI: Total time of Ignition, Avg HRR: Average Heat Release Rate, Pk HRR: Peak Heat Release Rate, Avg EHC: Average Effective Heat of Combustion, Avg CO: Average CO Yield, Avg CO₂: Average CO₂ Yield

The flammability of VPE/VPU blends was also similar to VPE and VPU showing excellent thermal resistant behaviour (FIG. 8). The chemical structure of DPO also played an important role that affected directly the adhesive performance. It was known that chemical composition is an important parameter that governs the flammability of the material^{[59]}. For example, the presence of aromatic structure in polyurethane would favour char formation during the thermal decomposition process^{[60]}. These results clearly show that, when compared to VE control, VPE, VPU and their blends exhibited excellent flame retardancy.

In addition, the exemplary VPE/FGO nanocomposites were investigated for flame retardant applications. Table 6 represents the cone calorimetry results of exemplary VPE/FGO nanocomposites. It can be seen that the neat VE resin value of Pk HRR and Avg HRR are 1499.00 and 144.73 kW/m² respectively. After incorporating phosphorus in to the VE the Avg HRR, Pk HRR, Avg EHC, CO yield and CO₂ yield were all decreased from 144.73 to 137.68 kW/m², 1499.00 to 509 kW/m², 24.62 to 12.96 MJ/kg, 0.19 to 0.17 kg/kg and 1.87 to 0.92 kg/kg respectively. A further reduction in Avg HRR, Pk HRR, Avg EHC, TSP, CO yield and CO₂ yield were also achieved by the addition FGO. The above results indicated that the addition of FGO significantly reduced the HRR, THR and EHC of VPE, thus enhancing the flame retardancy. Even though the charing and degradation mechanism of VPE is similar to the previous study, FGO contributed to the enhancement in the flame retardant properties of VPE/FGO nanocomposites. FGO promoted the condensed phase mechanism with the barrier effect of graphene oxide further retarding the transfer of heat and radical groups through the insulating char layer during the course of fire and hindering the escape of volatile degradation products. Additionally, the catalytic carbonization of the functionalized flame retardant triggered by FGO reduced the release of volatile pyrolysis products.

TABLE 6

Cone calorimetry, LOI and UL-94 results of thermally cured VE, VPE and VPE/FGO nanocomposites

| Sample Code | Avg HRR (kW/m²) | Pk HRR (kW/m²) | Avg EHC (MJ/kg) | Avg CO (kg/kg) | Avg CO₂ (kg/kg) | LOI & UL-94 | |
|---|---|---|---|---|---|---|---|
| | | | | | | LOI (%) | Rating |
| VE | 144.73 | 1499.00 | 24.62 | 0.19 | 1.87 | 21.4 | Unrated |
| VPE | 137.68 | 509.00 | 12.96 | 0.17 | 0.92 | 26.6 | V0 |
| VPE/3%FGO | 136.51 | 465.14 | 13.47 | 0.17 | 0.92 | 27.1 | V0 |
| VPE/5%FGO | 132.22 | 457.46 | 14.38 | 0.17 | 0.89 | 27.3 | V0 |
| VPE/7%FGO | 128.13 | 445.35 | 14.99 | 0.16 | 0.88 | 28.2 | V0 |
| VPE/9%FGO | 120.90 | 391.27 | 13.01 | 0.15 | 0.85 | 29.1 | V0 |

Avg HRR: Average Heat Release Rate, Pk HRR: Peak Heat Release Rate, Avg EHC: Average Effective Heat of Combustion, Avg CO: Average CO Yield, Avg CO₂: Average CO₂ Yield, LOI: Limited Oxygen Index, FGO: Functionalized Graphene Oxide

### (V) FTIR Analysis

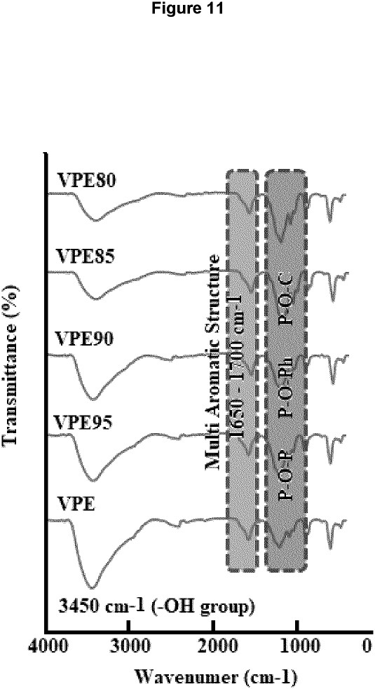

In order to characterize the char residues, FTIR measurements were performed and results are shown in FIG. 11. These char residues were obtained after the samples were heated in a muffle furnace at 600 oC for 20 min^{[61]}. It is obvious that the spectra of all samples showed similar char structures to the spectrum of VPE. For VPE, the broadened peak at 3450 cm-1 was attributed to the OH group. However, for all VPE/VPU blends, the intensity of peak (3450 cm-1) was gradually reduced with an increase in the amount of VPU, implying the existence of cross linking reactions between VPE and VPU. The broadened peak at approximately 1650 - 1700 cm-1 revealed the multi-aromatic structure formed during combustion^{[62]}. However, an intensive peak at approximately 1160 cm-1 indicated the presence of P-O-P, P-O-Ph and P-O-C[63]. Without being bound by theory, it is expected that the decomposition products from diphenylphosphine oxide and VPE/VPU reacted with each other to form crosslinked phosphorocarbonaceous and phosphorooxidative char with highly carbonized aromatic networks^{[64]}. Since char layer with high thermal stability will act as a barrier to mass and heat transfer between the gas phase and the condensed phase, prevent the escape of organic volatiles, and decrease the heat release rate during combustion^{[64,} ^{65]}, char layer composed of multi aromatic carbon and phosphorus containing structures are desirable for increasing fire resistance. Therefore, this study revealed a promising approach of applying interpenetrating network structures for enhancing fire safety of polymers. The strategy of forming interpenetrating network from phosphorus functionalized epoxy and polyurethane can also be applied in other polymer systems to enhance their fires resistance.

To investigate the flame-retardancy mechanism, structural characterization of the char residues of VPE and VPE/FGO composites was also performed by FTIR studies. These char residues were obtained after the samples were heated in a muffle furnace at 600° C. for 20 min. The spectra of all samples showed similar char structures due to their similarity to the spectrum of VPE. For VPE, the broadened peak at 3455 cm⁻¹ was attributed to the OH group. Vibration absorption peaks at 2954, 2911, and 2848 cm⁻¹ corresponded to the -CH, -CH₂, and -CH₃ groups, respectively. The peaks approximately at 1700 cm⁻¹ revealed that the multi-aromatic structures of the residue char. In addition, the strong absorption peaks at 1260 and 1080 cm⁻¹ were due to the presence of P-O-P, P-O-Ph and P-N bonds located in the VPE/FGO composites. The decomposition products from phosphate fragmentation and epoxy resins reacted with each other to form cross-linked phosphor carbonaceous and phosphor oxidative char with highly carbonized aromatic networks. The char layer, composed of multi-aromatic carbon and phosphorus containing structures, exhibited high thermal stability, and thus acted as an effective barrier to protect the matrix underneath from decomposing at high temperatures. This study was consisted with the findings from TGA and GC-MS studies

### (VI) DSC Studies of the Uncured VPE Resins and Cured VPE/FGO Composites

The dynamic DSC curves recorded at the heating rate (β) = 20° C. / min for the neat VE, VPE and VPE/FGO nanocomposites show that VPE and VPE/FGO nanocomposites underwent oxirane ring opening polymerization without phase transformation. The addition of FGO decreased the onset and maximum peak temperature (Tp) of the curing reactions. While not wishing to be bound by theory, this could be caused by reactive hydrogens from the remaining —OH and —COOH groups on the FGO surfaces accelerating curing reactions in the epoxy-amine systems. When compared to GO, the surface of FGO still had some reactive hydrogens from —OH and —COOH group at 3418 cm⁻¹ after the functionalization of GO. The FGO sample with a high content of hydrogencontaining groups and a good dispersion state could show a higher accelerating effect on the curing reactions. This indicated that FGOs could act as catalysts to promote the curing reaction. The curing enthalpy (ΔH) of the FGO/epoxy nanocomposites was smaller than that of the neat epoxy system. The ΔH value decreased from 135.60 J/g for neat epoxy to 110.3 J/g for graphene oxide/epoxy nanocomposite with an addition of 9 wt% FGO. This indicated that the oxygen functionalities present on the surface of the functionalized graphene oxide (FGO) acted as catalysts to accelerate the curing reaction between the epoxide and the amine groups.

The glass transition temperatures (Tg) of the VPE/FGO nanocomposites were slightly shifted to a lower temperature when compared to those of the neat VE and VPE. While not wishing to be limited by theory, this decrease could be due to two reasons. First, FGO could interfere with the curing of epoxy by unbalancing the stoichiometry of the curing reaction, resulting in less cross-linking. Second, a larger amount of the solvent was required to disperse the higher loadings of FGO, which also needed a prolonged heating to evaporate the solvent completely. As a result, the possibility of reactions between the solvent and epoxy could not be ruled out, which would also reduce the degree of cross-linking. Similarly, several previous studies of graphene containing epoxy composites reported the shifting of Tg towards lower temperatures. A lower Tg was attributed to the increase in free volume which rendered easier movement of the uncured epoxy and the entrapment of the residual solvent in the polymer matrix.

### G) Effects of FGO on Curing Kinetics

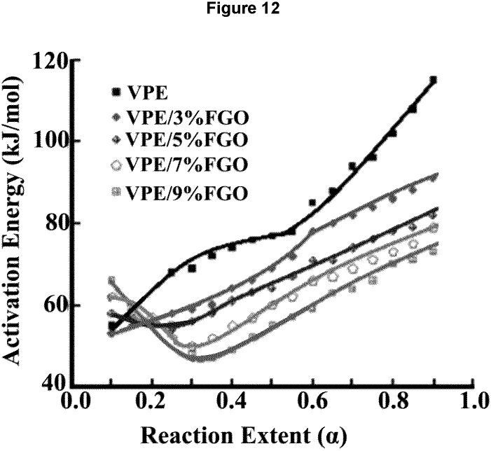

FIG. 12 plots activation energy (Ea) versus reaction extent (α) for the neat VPE resin and VPE/FGO nanocomposites. The values of Ea for VPE were relatively lower at α = 0.1 when compared to that of VPE/FGO nanocomposites except for VPE/3%FGO. For VPE, Ea values increased steadily with the increase in the reaction extend from α = 0.1 to 0.55. After α reached 0.6, the Ea values increased sharply until the end of the reaction. A similar behavior was noted for the VPE/3% FGO sample, but with slightly lower Ea values than those of neat VPE. Thus, even at the lowest level (3%) of FGO addition, the curing reaction of VPE was affected by the presence of FGO. The trend for VPE/5%FGO, VPE7%FGO, and VPE/9%FGO nanocomposites was different. At the initial stage of the reaction, i.e. α = 0.1, a higher Ea value was noted for VPE/5%FGO, VPE/7%FGO and VPE/9%FGO when compared to neat VPE. For these three types of nanocomposites, the Ea values were gradually decreased when α increased from 0.1 to 0.35. While not wishing to be limited by theory, the decline in Ea values was mainly attributed to the autocatalytic curing reaction through epoxide ring opening initiated by FGO. When α became higher than 0.4, the Ea values gradually increased until the end of the curing reaction, which corresponded with the progress of the epoxy ring opening reaction at different stages of the curing process. While not wishing to be limited by theory, the rise of E_{α} at the higher reaction extent (α = 0.4-0.9) was probably due to the increase in the cross-linking density of the chemical structure, leading to more constrains on the movement of the molecular segments in the curing process to result in the increase in the activation energy.

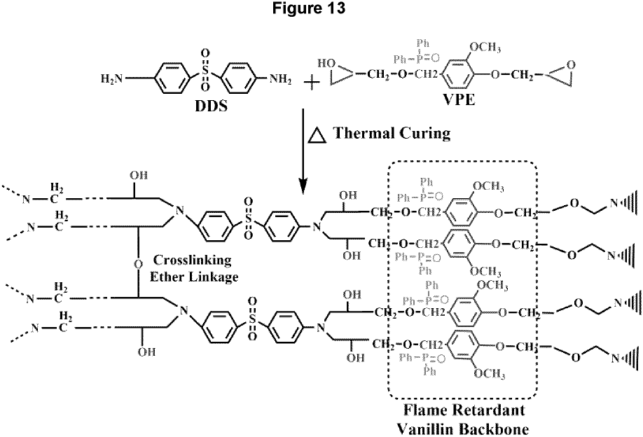

Again, while not wishing to be limited by theory, the ring opening polymerization reaction mechanisms for the neat epoxy resins (VPE) in curing is proposed in FIG. 13. In the initial stage of curing, primary amine group present in DDS opened the epoxy ring leading to the generation of secondary amine and hydroxyl groups. The generated secondary amine caused the formation of tertiary amine with a rise in hydroxyl groups. Lastly, the hydroxyl groups led to the formation of branched ether linkages. A Similar reaction mechanism can be expected for VPE/FGO nanocomposites. For VPE/FGO systems, the cure initiation reaction was slightly hindered due to the presence of carboxylic acid groups present in FGO, which neutralized the basic amine groups of the hardener to result in the formation of amide linkages during the curing reaction, thereby leading to higher activation energies at the initial degree of conversions (α), when compared to the neat epoxy system (VPE).

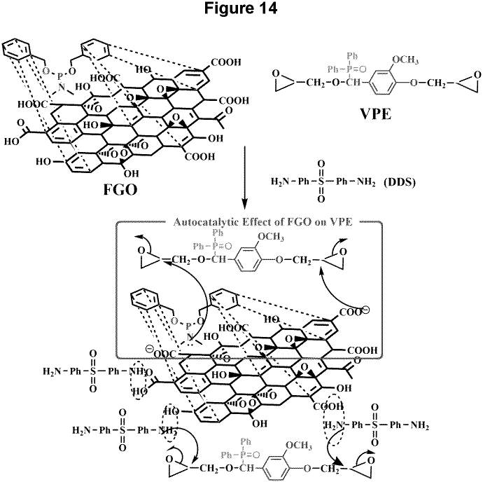

As the curing reaction proceeded, the autocatalytic effect of FGO on VPE took place as what is shown in FIG. 14. It involved both addition and etherification reactions. As represented in FIG. 14, carboxyl (or hydroxyl) groups on FGO formed hydrogen bonding with VPE, followed by the formation of a VPE-FGO-DDS trimolecular transitional complex. The complex formation proceeded with further epoxide ring openings. Subsequently, secondary amine from DDS was formed after fast proton transfer. The resultant secondary amine could react with the remaining VPE in a similar manner to FGO showing an autocatalytic effect. Moreover, there was another possibility that the tertiary amine present in the FGO as part of the DDP molecule could also serve as a catalyst to accelerate the curing reactions between the epoxide and the amine groups. Jouyandeh et al.,^{[67]} showed that the major functionalities present in FGOs were ketones, six membered lactol rings, tertiary alcohol, and epoxide and hydroxyl groups. Therefore, the oxygen functionalities present on the surface of FGOs catalyzed the curing reaction between the VPE epoxide and DDS amine groups.

### H) Summary

In the present application, exemplary novel bio-based flame retardant building block (VP, I-a) was successfully synthesized using diphenyl phosphine oxide and vanillin as the starting raw materials. This exemplary building block was then further reacted with epichlorohydrin and diphenyl methane diisocyanate to prepare exemplary flame retardant vanillin epoxy (VPE, II-a) and exemplary vanillin polyurethane (VPU, III-a) resins and blends. Chemical structures of these resins were successfully confirmed by FTIR, ¹H, ¹³C and ³¹P NMR studies. The novel synthesis routes developed in the present application were straightforward with excellent yields and low number of reaction steps, showing good promise for industrial implementation of the novel bio-based flame retardant building block as a platform technology. Using a blending technique, polyurethane (VPU) phase has been introduced into the epoxy (VPE) network to form more cross linked and stronger interpenetrating networks for enhanced thermal and mechanical properties of the resulting resins. It was found that the VPE/VPU blends exhibited a significant increase in storage modulus and lap shear dry and wet bonding strength of the final cured resins. The maximum lap shear bonding strength and storage modulus has been achieved at VPE/VPU blending ratios of 80:20 by weight in this study. TGA studies showed that the incorporation of VPU to VPE resulted in the onset of earlier decomposition at lower temperatures attributed to the earlier decomposition of phosphorus groups in PU. Nevertheless, this decrease in thermal stability was accompanied by a significant increase in char yield and a drastic reduction in flammability. The results of flame resistance tests indicated that VPE combined with VPU had excellent flame-retardant properties. From the cone calorimetry test, The HRR, THR, TSP, Avg-EHC, Avg-CO and Avg-CO₂ results of VPE, VPU and their blends were significantly superior than those of VE control without phosphorous and their values decreased with the increase in the amount of VPU addition to VPE up to 20 wt.%. The approach developed in the present application presents a novel promising pathway for synthesis of a new family of fire resistant and thermally stable bio-based epoxy and polyurethane (PU) resins based on renewable feedstock. The strategy of functionalization of flame-retardant organic phosphorus compound with high aromaticity onto the vanillin epoxy and PU backbone is highly attractive since it can simultaneously improve both flame resistance and mechanical properties of the resulting resins. These high performance bio-based flame resistant compounds and adhesives has excellent potential to be used as sustainable green alternatives to existing petroleum-derived epoxy and PU resins for a wide range of industrial applications.

Also in the present application, the bio-based phosphorus containing flame-retardant epoxy resin from vanillin was combined with functionalized GO to make high performance flame-retardant nanocomposites. The incorporation of FGO accelerated the curing reactions of the resin, indicating that FGO had a catalytic role in reducing the curing time. The TGA study showed that even though FGO addition to VPE reduced the earlier decomposition temperature, a significant enhancement effect was found on the char residue caused by the flame-retardant additives catalyzing the degradation of polymers to form the protective char. It was also observed that VPE/FGO nanocomposites showed excellent dry and wet bonding strengths. In addition to the remarkable bonding performance, the VPE/FGO nanocomposites exhibited a superior self-extinguishing flame-retardancy. Especially, VPE/9%FGO sample achieved both the highest LOI value (29.1%) and a UL-94 rating of V-0. From the cone calorimetry test, The HRR, THR, TSP, Avg EHC, Avg CO, and Avg CO₂ of VPE and VPE/FGO nanocomposites were decreased with the increase in the content of FGO compared to those of neat VE. FTIR analysis of the char residues showed an increased intensity of absorption bands of P-O-C, P-O-P, and P-N indicating that P and N elements from FGO retained in the residues. The char layer provided effective shielding to protect the underlying polymers against flame. This study demonstrated that the non-covalent functionalization of graphene oxide with flame-retarding compounds provided a novel attractive approach to simultaneously enhance flame retardancy and mechanical strength of the epoxy adhesives.

### Example 2: Microwave Curing of VPE

The results in this example demonstrate that VPE is microwave curable.

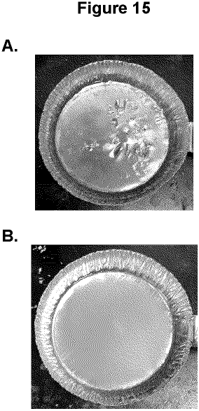

VPE was dissolved in acetone with stoichiometric amount of an aliphatic diamine. The solution was vigorously mixed, poured into an aluminium pan, and left at room temperature overnight to remove the solvent. The following two curing procedures were applied using a conventional household microwave oven (Master Chef EM720CPT-PM-700 watts, operating at frequencies of 2.45 to 2.5 GHz. MCA Corporation):
(i) Power level - 10 (100% power); heat for 3 min, remove from the microwave oven and cool at room temperature for 1 min; repeat this 3-1 min heating-cooling cycle 5 times. (FIG. 15, panel A)
(ii) Power level - 10 (100% power); heat for 2 min, remove from the microwave oven and cool at room temperature for 1 min; repeat this 2-1 heating-cooling cycle 5 times. (FIG. 15, panel B)

While the present application has been described with reference to examples, it is to be understood that the scope of the claims should not be limited by the embodiments set forth in the examples, but should be given the broadest interpretation consistent with the description as a whole.

All publications, patents and patent applications are herein incorporated by reference in their entirety to the same extent as if each individual publication, patent or patent application was specifically and individually indicated to be incorporated by reference in its entirety. Where a term in the present application is found to be defined differently in a document incorporated herein by reference, the definition provided herein is to serve as the definition for the term.

### FULL CITATIONS FOR DOCUMENTS REFERRED TO IN THE SPECIFICATION

A number of publications are cited herein. Full citations for these references are provided below. Each of these references is incorporated herein by reference in its entirety into the present disclosure, to the same extent as if each individual reference was specifically and individually indicated to be incorporated by reference.

1. Maxence. F, Emilie. D, Vincent. B, Remi. A, Sylvain. C, and Bernard. B., “Vanillin, a promising biobased building-block for monomer synthesis”, Green Chem., 2014, 16, 1987 - 1998.

2. Audrey. L, Etienne. G, Stephane. C, Stephane. G and Henri. C., “From Lignin-derived Aromatic Compounds to Novel Biobased Polymers”, Macromol. Rapid. Comm., 2016, 37, 9-28.

3. Maulidan. F and Michael. A. R. M., “Renewable co-polymers derived from vanillin and fatty acid derivatives”, Eur. Polym. j., 2013, 49, 156-166.

4. De Espinosa. L. M, Meier. M. A. R, Ronda. J. C, Galia. M and Cadiz. V., “Phosphorus containing renewable polyester-polyols via ADMET polymerization. Synthesis, functionalization and radical cross-linking”, J. Polym. Sci. Part A: Polym. Chem., 2010, 48, 1649-60.

5. Wu. J. N, Chen. L, Fu. T, Zhao. H. B, Guo. D. M, Wang, X. L and Wang. Y. Z. “New application for aromatic Schiff base: High efficient flame-retardant and anti-dripping action for polyesters”, Chem. Eng. J., 2018, 336, 622-632.

6. Holmcsc, A., “Effect of fire-retardant treatments on performance properties of wood”. In I. S. Goldstein, ed. ACS Symposium Series 43, Wood technology: Chemical aspects. ACS, Washington, DC. 1977, 82-106.

7. Wazarkar. K, Kathalewar. M and Sabnis. A. “Improvement in flame retardancy of polyurethane dispersions bynewer reactive flame retardant”, Prog. Org. coat., 2015, 87 75-82.

8. Park. H, Keun. J and Lee, K. “Syntheses and physical properties of two-component polyurethane flame-retardant coatings using chlorine-containing modified polyesters”, J. Polym. Sci.: Part A: Polym. Chem., 1996, 34, 1455-1464.

9. Hong-Soo Park, Dae-Won Kim, Kyu-Hyun Hwang, Byung-Seon Yoon, Jong-PyoWu, Jin-Woo Park, Hyun-Sik Hahm, Wan-Bin Im, “Preparation and characterization of polyurethane flame-retardant coatings using pyrophosphoric lactone-modified polyesters/isophorone diisocyanate-isocyanurates”, J. Appl. Polym. Sci., 2001, 80, 2316-2327.

10. Hong-Soo Park, Hyun-Sik Hahm, Eun-Kyunc Parkz, “Preparation and characteristics of two-component polyurethane flame retardant coatings using 2, 3-dibromo modified polyesters”, J. Appl. Polym. Sci., 1996, 61, 421-429.

11. Borges da Silva. E. A, Zabkova. M, Araújo. J. D, Cateto. C. A, Barreiro. M. F, Belgacem. M. N and Rodrigues. A. E. “An integrated process to produce vanillin and lignin-based polyurethanes from Kraft lignin”, Chem. Eng. Res. Des., 2009, 87, 1276-1292.

12. Thielemans. W, Can. E, Morye. S.S. and Wool, R.P., “Novel applications of lignin in composite materials”. J. Appl. Polym. Sci., 2002, 83, 323-331.

13. Saake, B. and Lehnen, R., “Lignin, in: Ullmans’s Encyclopedia of Industrial Chemistry”, 7th Edition (Internet version 2003, CD-ROM 2004), Karin Sora (ed.) (Wiley-VCH Verlag GmbH & Co. KGaA, Weinheim, Germany).

14. Borges da Silva. E. A, Zabkova. M, Araújo. J. D, Cateto. C. A, Barreiro, M. F, Belgacem. M. N and Rodrigues, A. E., “An integrated process to produce vanillin and lignin-based polyurethanes from Kraft lignin”, Chem. Eng. Res. Des., 2009, 87, 1276-1292.

15. Wong. Z, Chen. K and Li. J., “Formation of vanillin and syringaldehyde in an oxygen delignification process”, Bio Resources, 2010, 5, 1509-1516.

16. Araújo. J. D. P, Grande. C. A and Rodrigues. A. E., “Vanillin production from lignin oxidation in a batch reactor”, Chem. Eng. Res. Des., 2010, 88, 1024-1032.

17. Fache. M, Darroman. E, Besse. V, Auvergne. R, Caillol. S and Boutevin. B. “Vanillin, a promising biobased building-block for monomer synthesis”, Green. Chem., 2014, 16, 1987-1998.

18. Issam. A. M. and Rashidah. M. H., “Synthesis of New Liquid Crystalline Diglycidyl Ethers”, Molecules, 2012, 17, 645-656.

19. Srinivasa Rao, V and Samui. A. B., “Molecular engineering of photoactive liquid crystalline polyester epoxies containing benzylidene moiety”, J. Polym. Sci. Part A: Polym. Chem., 2008, 46, 7637-7655.

20. Srinivasa Rao. V and Samui A. B., “Structure-property relationship of photoactive liquid crystalline polyethers containing benzylidene moiety”, J. Polym. Sci. Part A: Polym. Chem., 2009, 47, 2143-2155.

21. The European Parliament and the European Council: Off. J. Eur. Union, 2003, Directive 2002/96/EC of 27.

22. Wang. X, Hu. Y, Song L, Xing. W and Lu. H., “Thermal degradation behaviors of epoxy resin/POSS hybrids and phosphorus-silicon synergism of flame retardancy”. J. Polym. Sci. Pol. Phys., 2010, 48, 693-705.

23. Lin. C. H, Lin. H. T, Tian. Y. W, Dai. S. A, Su. W. C., “Preparation of phosphinated bisphenol from acid-fragmentation of 1,1,1-tris(4-hydroxyphenyl) ethane and its application in high-performance cyanate esters”, J. Polym. Sci. Pol. Chem., 2011, 49, 4851-4860.

24. Serbezeanu. D, Vlad-Bubulac. T, Hamcicuc. C and Aflori. M., “Synthesis and properties of novel phosphorus-containing thermotropic liquid crystalline copoly(ester imide)s”, J. Polym. Sci. Pol. Chem., 2010, 48, 5391-5403.

25. Lin. C. H, Chang. S. L and Wei. T. P., “High-Tg transparent poly(-ether sulfone)s based on phosphinated bisphenols”, Macromol. Chem. Phys., 2011, 212, 455-464.

26. Yan. L, Liu. J. P, Zheng. N and Zheng. Y. B., “Copolymerization of (10-oxo- 10-hydro-9-oxa-10-5-phosphaphenanthrene-10-yl)-methyl acrylate with styrene”, Chinese. Chem. Lett., 2009, 20, 881-884.

27. Huang, S. Hou. X, Li. J, Tian. X, Yu, Q and Wang. Z., “A novel curing agent based on diphenylphosphine oxide for flame-retardant epoxy resin”, DOI: 10.1177/0954008317745957

28. Kobilka. B. M, Kuczynski. J, Porter. J. T and Wertz. J. T., “Flame retardant Vanillin Derived small Molecules”, U.S. Pat. No. US10, 214,693B2, February 2019.

29. Kobilka. B. M, Kuczynski. J, Porter. J. T and Wertz. J. T.,“Bondable Flame retardant Vanillin Derived Molecules”, U.S. Pat. No. US10, 266,771B2, April 2019.

30. Kobilka. B. M, Kuczynski. J, Porter. J. T and Wertz. J. T., “Bondable Flame retardant Vanillin Derived Molecules”, U.S. Pat. No. US2018 / 0320073A1, November 2018.

31. Kobilka. B. M, Kuczynski. J, Porter. J. T and Wertz. J. T., “Bondable Flame retardant Vanillin Derived Molecules”, U.S. Pat. No. US2018 / 0320075A1, November 2018.

32. Wan. J, Li. C, Fan. H and Li. B. G., “Branched 1,6-Diaminohexane-Derived Aliphatic Polyamine as Curing Agent for Epoxy: Isothermal Cure, Network Structure, and Mechanical Properties”, Ind. Eng. Chem. Res., 2017, 56, 4938-4948.

33. Zhu. Z. M, Wang. L. X, Lin, X. B and Dong. L. P., “Synthesis of a novel phosphorus-nitrogen flame retardant and its application in epoxy resin”, Polym. Deg. Stabil., 2019, 169, 108981.

34. Kim. M, Ko. H and Park, S. M., “Synergistic effects of amine-modified ammonium polyphosphate on curing behaviors and flame retardation properties of epoxy composites”, Compos. Part B- Engg., 2019, 170, 19-30.

35. Shen, D, Xu. Y. J, Long. J. W, Shi. X. H, Chen. L and Wang. Y. Z., “Epoxy resin flame-retarded via a novel melamine-organophosphinic acid salt: Thermal stability, flame retardance and pyrolysis behaviour”, J. Anal. Appl. Pyrol., 2017, 128, 54-63.

36. Sperling. L and Hu. R., “Interpenetrating polymer networks. Polymer blends handbook”,. Berlin: Springer; 2014. p. 677-724.

37. Lv. X, Huang. Z, Huang. C, Shi. M, Gao. G and Gao Q., “Damping properties and the morphology analysis of the polyurethane/epoxy continuous gradient IPN materials”, Compos. Part B. Eng., 2016, 88, 139-49.

38. Kostrzewa. M, Hausnerova. B, Bakar. M and Dalka. M., “Property Evaluation and Structure Analysis of Polyurethane/Epoxy Graft Interpenetrating Polymer Networks”, J Appl. Polym. Sci., 2011, 122, 1722-1730.

39. Shan. H, Xiao. H, Jiaojiao. L, Xiujuan. T, Qing. Y and Zhongwei. W., “A novel curing agent based on diphenylphosphine oxide for flame-retardant epoxy resin”, High Perform. Polym., 2018, 30, 1-11.

39. Wang. X, Zhou. S, Guo. W-W, Wang. P. L, Song. X. L and Hu. Y., “Renewable cardanol-based phosphate as a flame retardant toughening agent for epoxy resins”, ACS Sustainable. Chem. Eng., 2017, 5, 3409- 3416.

40. Lin. C. H, Cai. S. X and Lin. C. H., “Flame-retardant epoxy resins with high glasstransition temperatures. II. Using a novel Hexafunctional curing agent: 9,10- Dihydro-9-oxa-10-phosphaphenanthrene10-yl-tris(4-aminophenyl) methane”, J. Polym. Sci. Polym. Chem., 2005, 43, 5971-5986.

41. Haemin. G, Daewoo. L, Kwon-Young. C, Han-Na. K, Hoon. R, Dai-Soo. L and Byung-Gee. K., “Development of High Performance Polyurethane Elastomers Using Vanillin-Based Green Polyol Chain Extender Originating from Lignocellulosic Biomass”, ACS Sustainable Chem. Eng. 2017, 5, 4582-4588.

42. Pizzi, A and Mittal, K. L Handbook of Adhesion Technology 2^{nd} ed., Marcel Dekker, New York, 2003.

43. Van der Linden, M. L. R. in Cost Action E 13, Vol. 2, Glued Wood Products, European Community, Luxembourg, 2002, 120.

44. Chen. S, Wang. Q, Wang. T and Pei. X., “Preparation, damping and thermal properties of potassium titanate whiskers filled castor oil-based polyurethane/epoxy interpenetrating polymer network composites”, Mater Des. 2011, 32, 803-807.

45. Chin-Hsing. C and Yun-Yun. S., “Mechanical Properties of Blocked Polyurethane/Epoxy Interpenetrating Polymer Networks”, J Appl. Polym. Sci., 2006, 101, 1826-1832.

46. Chartoff. R. P, Weissman. P. T and Sircar, A., “The application of dynamic mechanical methods to Tg determination in polymers: an overview”, Assignment of the glass transition. West Conshohocken: ASTM International; 1994.

47. Wang. S, Ma. S, Li. Q, Xu. X, Wang. B, Yuan. W, Zhou. S, You. S and Zhu. J., “Facile in situ preparation of high-performance epoxy vitrimer from renewable resources and its application in nondestructive recyclable carbon fiber composite”, Green Chem., 2019, 21, 1484-1497.

48. Xu. X, Ma. S, Wu. J, Yang, J, Wang, B, Wang. S, Li. Q, Feng. L, You. S and Zhu. J., “High-performance, command-degradable, antibacterial Schiff base epoxy thermosets: synthesis and properties”, J. Mater. Chem. A, 2019, 7, 15420 - 15431.

49. Heyu. C and Ning. Y., “Application of Western red cedar (Thuja plicata) tree bark as a functional filler in pMDI wood adhesives”, Ind. Crop. Prod., 2018, 113, 1-9.

50. Lucie. C, Fouad. L, Sylvain. B and Philippe. D., “Bio-based flame retardants: When nature meets fire protection”, Mat. Sci. Eng. R., 2017, 117, 1-25.

51. Haiyang. D, Kun. H, Shouhai. L, Lina. X, Jianling. X and Mei. L., “Synthesis of a novel phosphorus and nitrogen-containing bio-based polyol and its application in flame retardant polyurethane foam”, J Anal. Appl. Pyrol.., 2017, 128, 102-113.

52. Schartel. B, Braun, U, Balabanovich. A. I, Artner, J, Ciesielski. M, Dcoring. D, Perez. R. M, Sandler. J. K. Wand Altstcadt. V., “Pyrolysis and fire behaviour of epoxy systems containing a novel 9,10-dihydro-9-oxa-10-phosphaphenanthrene-10-oxide-(DOPO)-based diamino hardener”, Eur. Polym. J., 2008, 44, 704-715.

53. Chern, Y. C, Hsieh, K. H and Hsu, J. S., “Interpenetrating polymer networks of polyurethane crosslinked epoxy and polyurethanes”, J. Mater. Sci., 1997, 32, 3503-3509.

54. Chen. R, Hu. K, Tang. H, Wang. J, Zhu. F and Zhou. H., “A novel flame retardant derived from DOPO and piperazine and its application in epoxy resin: Flame retardance, thermal stability and pyrolysis behaviour”, Polym. Deg. Stabil., 2019, 166, 334-343.

55. Wang. P, Chen. L and Xiao. H., “Flame retardant effect and mechanism of a novel DOPO based tetrazole derivative on epoxy resin”, J. Anal. Appl. Pyrol., 2019, 139, 104-113.

56. Arora. S, Mestry. S, Naik. D and Mhaske. S. T., “o-Phenylenediamine-derived phosphorus-based cyclic flame retardant for epoxy and polyurethane systems”, Polymer Bulletin https://doi.org/10.1007/s00289-019-02910-z.

57. Menard, R, Negrell-Guirao. C, Ferry. L, Sonnier. R and David. G,“ Synthesis of biobased phosphate flame retardants”, Pure Appl. Chem., 2014, 86, 1637-1650.

58. Noreen. A, Zia. K. M, Zuber. M, Tabasum. S and Zahoor. A. F., “Bio-based polyurethane: an efficient and environment friendly coating systems: a review”. Prog. Org. Coat., 2016, 91, 25-32.

59. Zheng. X, Wang. G and Xu. X., “ Roles of organically-modified montmorillonite and phosphorous flame retardant during the combustion of rigid polyurethane foam”, Polym. Degrad. Stabil. 2014, 101, 32-39.

60. Liang. S, Neisius. M and Mispreuve. H., “Flame retardancy and thermal decomposition of flexible polyurethane foams: structural influence of organophosphorus compounds”, Polym. Degrad. Stabil., 2012, 97, 2428-2440.

61. Yu. B, Shi. Y, Yuan. B, Qiu. S, Xing. W, Hu, W, Song. L, Lo. S and Hu. Y., “Enhanced thermal and flame retardant properties of flame-retardant-wrapped graphene/epoxy resin nanocomposites”, J. Mater. Chem. A, 2015, 3, 8034 - 8044.

62. Liu. H, Wang. X and Wu. D., “Novel cyclotriphosphazene-based epoxy compound and its application in halogen-free epoxy thermosetting systems: Synthesis, curing behaviors, and flame retardancy”, Polym. Degrad. Stab., 2014, 103, 96-112.

63. Bugajny. M, Bourbigot. S, Bras, M. L and Delobel. R., “The origin and nature of flame retardance in ethylene-vinyl acetate copolymers containing hostaflam AP 750”, Polym. Int., 1999, 48, 264-270.

64. Wang. X, Hu. Y, Song. L, Xing. W, Lu. H, Lv. P and Jie. G, “Flame retardancy and thermal degradation mechanism of epoxy resin composites based on a DOPO substituted organophosphorus oligomer”, Polymer, 2010, 51, 2435-2445.

65. Potts. J. R, Dreyer. D. R, Bielawski. C. W and Ruoff. R. S., “Graphene-based polymer nanocomposites”, Polymer, 2011, 52, 5-25.

66. Zhang W, Li X, Yang R. Blowing-out effect and temperature profile in condensed phase in flame retarding epoxy resins by phosphorus-containing oligomeric silsesquioxane. Polym Advan Technol 2013; 24: 951-961.

67. Jouyandeh M, Yarahmadi E, Didehban K, Ghiyasi S, Paran SMR, Puglia D, Ali JA, Jannesari A, Saeb MR, Ranjbar Z, Ganjali MR. Cure kinetics of epoxy/graphene oxide (GO) nanocomposites: Effect of starch functionalization of GO nanosheets. Prog Org Coat 2019; 136: 105217.

What is claimed is:

1. A compound of Formula (I), 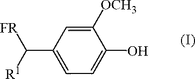
wherein,
FR is a phosphorus based flame retardant, and
R¹ is selected from OH and =O.

2. The compound of claim 1, wherein R¹ is OH and the compound of Formula (I) is a compound of Formula (I-A), 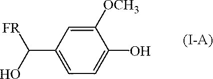
.

3. The compound of claim 1, wherein FR is selected from, 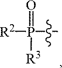 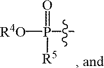 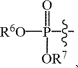
wherein
R², R³, R⁴, R⁵, R⁶ and R⁷ are independently selected from C₆₋₁₄aryl, C₁₋₁₀alkyl, C₂₋₁₀alkenyl, and C₂₋₁₀alkynyl, each of which are unsubstituted or substituted with one or more of F, Cl, C₁₋₄alkyl and C₁₋₄fluoroalkyl, or
R² and R³, R⁴ and R⁵ or R⁶ and R⁷ are linked to form, together with the atom(s) to which said groups are bonded, a monocyclic or a polycyclic, saturated, unsaturated and/or aromatic ring system having 4 or more carbon atoms in which one or more of the carbon atoms is optionally replaced with a heteroatom selected from O and N and which is unsubstituted or substituted with one or more of F, Cl and C₁₋₄alkyl; and 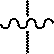
is a point of covalent attachment.

4-5. (canceled)

6. The compound of claim 3, wherein one of R² and R³, R⁴ and R⁵ or R⁶ and R⁷ is phenyl and the other is C₂₋₆alkenyl.

7. The compound of claim 3, wherein R² and R³, R⁴ and R⁵ or R⁶ and R⁷ are linked to form, together with the atom(s) to which said groups are bonded, a polycyclic, saturated, unsaturated and/or aromatic ring system having 6-14 carbon atoms in which 1-4 of the carbon atoms is optionally replaced with a heteroatom selected from O and N and which is unsubstituted or substituted with one or more of F, Cl and C₁₋₄alkyl.

8-13. (canceled)

14. The compound of claim 1, wherein the compound of Formula (I) is selected from

| | |
|---|---|
| Compound I.D | Structure |
| I-a (VP) | 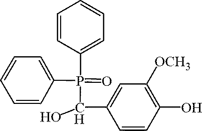 |
| I-b | 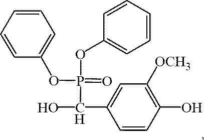 |
| I-c | 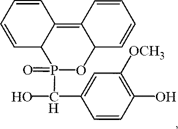 |
| I-d | 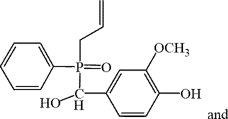 |
| I-e | 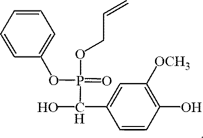 |

.

15-16. (canceled)

17. A compound of Formula (II) 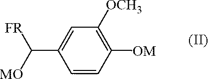
wherein
FR is a phosphorus based flame retardant, and
each M is, independently, a group comprising a polymerizable substituent.

18. The compound of claim 17, wherein FR is selected from 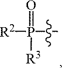 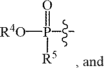 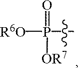
wherein R², R³, R⁴, R⁵, R⁶ and R⁷ are as defined in any one of claims 3 to 13.

19. The compound of claim 17, wherein the polymerizable substituent in M is selected from a methacryloyl, an epoxy, an alkenyl, an alkynyl, a cyanato, and an isocyanato, each being either directly bonded to the O or linked to the O via a linker group.

20. The compound of claim 19, wherein the linker group is C(O)NH, NHC(O), C₁₋₆alkylene, phenylene, diphenylene, diphenylene methane, diphenylene sulfoxide, diphenylene sulfone or diphenylene ether, or combinations thereof.

21-23. (canceled)

24. The compound of claim 17, wherein the compound of Formula (II) is a compound of Formula (II-a) (VPE). 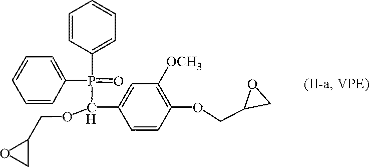
, or wherein the compound of Formula (II) is a compound of Formula II-b:

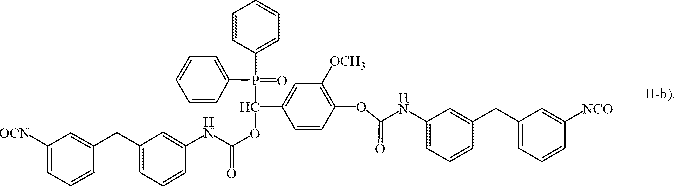

25. (canceled)

26. A compound of Formula (III): 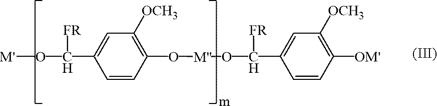
wherein
FR is a phosphorus based flame retardant;
M′ is a group comprising at least two polymerizable substituents wherein one polymerizable substituent has been reacted to form an O-linkage;
M″ is a group comprising at least two polymerizable substituents, wherein each polymerizable substituent has been reacted to form an O- linkage, and wherein the group comprising the at least two polymerizable substituents in M′ and M″ is the same; and m is a number of repeating units.

27-42. (canceled)

43. An interpenetrating polymer network (IPN) comprising a blend of a compound of Formula (II) and a compound of Formula (III) wherein the compound of Formula (II) is: 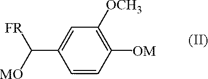
wherein
FR phosphorus based flame retardant, and is a
each M is each independently, a group comprising polymerizable substituent; and the compound of Formula (III) is: 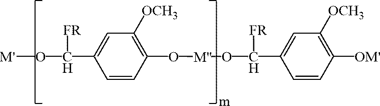 [SMILES: COc1cc(C=O)ccc1O]
wherein
FR is a phosphorus based flame retardant;
M′ is a group comprising at least two polymerizable substituents wherein one polymerizable substituent has been reacted to form an O-linkage;
M″ group comprising at least two polymerizable substituents, wherein each polymerizable substituent has been reacted to form an O-linkage, and wherein the group comprising the at least two polymerizable substituent in M′ and M″ is the same; and m is a number of repeating units.

44-48. (canceled)

49. A process for preparing a compound of Formula (I), comprising: 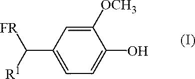
combining vanillin 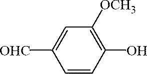
with a compound of Formula (IV) 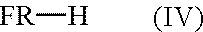
wherein
FR is a phosphorus based flame retardant, and
R¹ is OH,
under conditions to form the compound of Formula (I).

50-64. (canceled)

65. A process for preparing a compound of Formula (III), comprising 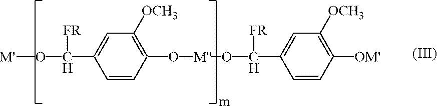
combining a compound of Formula (I) wherein R
¹ is OH 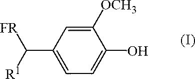
with a compound of Formula (VI) 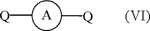
wherein
FR is a phosphorus based flame retardant;
M′ is 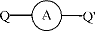
M″ is 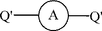
Q is a polymerizable substituent;
Q′ is a polymerizable substituent that has been reacted to form an O-linkage 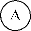
is a linker group selected from, C
₁₋₁₀alkylene, C₆₋₁₆arylene and Z(C₆₋₁₆arylene)₂,
Z is selected from C₁₋₆alkylene, O, S, SO₂, S=O, and NH;
FR is a phosphorus based flame retardant; and
m is a number of repeating units.
under conditions to form the compound of Formula (III).

66-71. (canceled)

72. A process for preparing an interpenetrating polymer network (IPN) comprising a blend of a compound of Formula (II) and a compound of Formula (III), comprising
combining a compound of Formula (II) 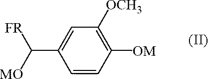
with a compound of Formula (III) 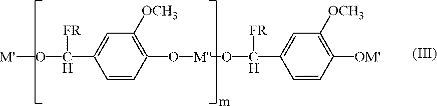
wherein
FR is a phosphorus based flame retardant;
M is a group comprising a polymerizable substituent;
M′ is a group comprising at least two polymerizable substituents wherein one polymerizable substituent has been reacted to form an O-linkage;
M″ is a group comprising at least two polymerizable substituents, wherein each polymerizable substituent has been reacted to form an O-linkage, and wherein the group comprising the at least two polymerizable substituents in M′ and M″ is the same; and m is a number of repeating units,
and curing the compound of Formula (II) and the compound of Formula (III).

73-82. (canceled)

83. A method of coating an article or a material with a flame retardant resin and/or prepolymer comprising applying a compound of Formula (II) and/or a compound of Formula (III), and optionally one or more additives, to the article or material and allowing the compound of Formula (II) and/or (III) to cure on the article or material, wherein the compound of Formula (II) is: 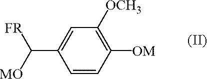
wherein
FR is a phosphorus based flame retardant, and
each M is, independently, a group comprising a polymerizable substituent; and
the compound of Formula (III) is: 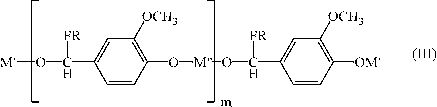
wherein
FR is a phosphorus based flame retardant;
M′ is a group comprising at least two polymerizable substituents wherein one polymerizable subsituent has been reacted to form an O-linkage;
M″ is a group comprising at least two polymeriazable substituents, wherein each polymerizable substituent has been reacted to form an O-linkage, and wherein the group comprising the at least two polymerizable substituents in M′ and M″ is the same; and
m is a number of repeating units.

84-86. (canceled)

87. A method of preparing a flame retardant nanocomposite comprising curing a compound or Formula (II) or a compound of Formula (III) in the presence of a curing agent and optionally one or more additives, wherein the compound of Formula (II) is : 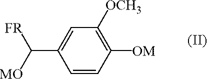
wherein
FR is a phosphorus based flame retardant, and
each M is, independently, a group comprising a polymerizable substituent; and
the compound of Formula (III) is: 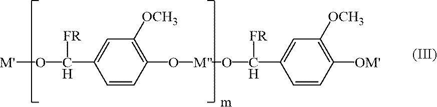
wherein
FR is a phosphorus based flame retardant;
M′ is a group comprising at least two polymerizable substituents wherein one polymerizable substituent has been reacted to form an O-linkage;
M″ is a group comprising at least two polymerizable substituents, wherein each polymerizable substituent has been reacted to form an O-linkage, and wherein the group comprising the at least two polymerizable substituents in M′ and M″ is the same; and
m is a number of repeating units.

88-95. (canceled)

96. A nanocomposite prepared by curing a compound of Formula (II) or a compound of Formula (III) in the presence of a curing agent and optionally one or more additives, wherein the compound of Formula (II) is: 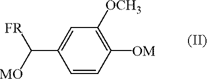
wherein
FR is a phosphorus based flame retardant, and
each M is, independently, a group comprising a polymerizable subsituent; and
the compound of Formula (III) is: 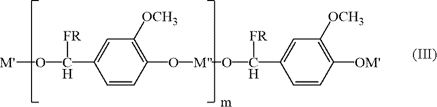
wherein
FR is a phosphorus based flame retardant;
M′ is a group comprising at least two polymerizable substituents wherein one polymerizable substituent has been reacted to form an O-linkage;
M″ is a group comprising at least two polymerizable substituents, wherein each polymerizable substituent has been reacted to form an O-linkage, and wherein the group comprising the at least two polymerizable substituents in M′ and M″ is the same; and
m is a number if repeating units.

97-100. (canceled)

101. A method of coating an article or a material with a flame retardant nanocomposite coating comprising applying a compound of Formula (II) or a compound of Formula (III), a curing agent and optionally one or more additives, to the article or material and allowing the compound of Formula (II) or (III) to cure on the article or material, wherein the compound of Formula (II) is: 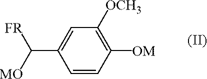
wherein
FR is a phosphorus based flame retardant; and
each M is, independently, a group comprising a polymerizable substituent; and
the compound of Formula (III) is: 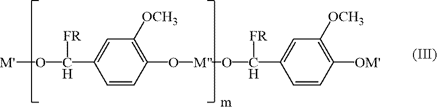
wherein
FR is a phosphorus based flame retardant;
M′ is a group comprising at least two polymerizable substitunets wherein one polymerizable substituent has been reacted to form an O-linkage;
M″ is a group comprising at least two polymerizable substituents wherein each polymerizable substituent has been reacted to form an O-linkage, and wherein the group
comprising the at least two polymerizable substituents in M′ and M″ is the same: and m is a number of repeating units.
